(19) United States
(12) Patent Application Publication
(10) Pub. No.: US 2026/0231042 A1
(43) Pub. Date: Aug. 6, 2026

(54) WIRELESS COMMUNICATION METHOD, AND COMMUNICATION DEVICE

(71) Applicant: GUANGDONG OPPO MOBILE TELECOMMUNICATIONS CORP., LTD., Dongguan (CN)

(72) Inventors: Shengjiang CUI, Dongguan (CN); Chuanfeng HE, Dongguan (CN)

(21) Appl. No.: 19/575,884

(22) Filed: Mar. 23, 2026

Related U.S. Application Data
(63) Continuation of application No. PCT/CN2023/122142, filed on Sep. 27, 2023.

(51) Int. Cl. H04W 52/02

(52) U.S. Cl. CPC H04W 52/0261

(57) ABSTRACT

A wireless communication method and a communication device. The method is performed by a terminal device, and the method includes: transmitting, based on an energy state of the terminal device, at least one of first information or second information to a network device, wherein the first information includes complete report data or partial report data of the terminal device, and the second information is used to indicate the energy state of the terminal device.

### CROSS-REFERENCE TO RELATED APPLICATION

This application is a continuation of International Application No. PCT/CN2023/122142, filed Sep. 27, 2023, the entire disclosure of which is incorporated herein by reference.

### TECHNICAL FIELD

Embodiments of the present disclosure relate to the field of communication technologies, and in particular, relate to a wireless communication method and a communication device.

### RELATED ART

Zero-power terminal devices acquire energy for communication by harvesting ambient energy. Compared with traditional terminal devices with batteries, the communication of the zero-power terminal devices is affected by energy states of the terminal devices.

### SUMMARY

Embodiments of the present disclosure provide a wireless communication method and a communication device. The technical solutions are as follows:

According to some embodiments of the present disclosure, a wireless communication method is provided. The method is performed by a terminal device, and the method includes: transmitting, based on an energy state of the terminal device, at least one of first information or second information to a network device, wherein the first information includes complete report data or partial report data of the terminal device, and the second information is used to indicate the energy state of the terminal device.

According to some embodiments of the present disclosure, a communication device is provided. The communication device includes a processor and a memory storing one or more computer programs, wherein the one or more programs, when loaded and run by the processor, cause the processor to receive at least one of first information or second information from a terminal device, wherein the first information includes complete report data or partial report data of the terminal device, and the second information is used to indicate an energy state of the terminal device.

According to some embodiments of the present disclosure, a communication device is provided. The communication device includes a processor and a memory storing one or more computer programs, wherein the one or more programs, when loaded and run by the processor, cause the processor to transmit, based on an energy state of a terminal device, at least one of first information or second information to a network device, wherein the first information includes complete report data or partial report data of the terminal device, and the second information is used to indicate the energy state of the terminal device.

### BRIEF DESCRIPTION OF DRAWINGS

FIG. 1 is a schematic diagram of a network architecture according to some embodiments of the present disclosure;

FIG. 2 is a schematic structural diagram of a zero-power communication system according to some embodiments of the present disclosure;

FIG. 3 is a schematic diagram of a principle of radio frequency power harvesting (RFPH) according to some embodiments of the present disclosure;

FIG. 4 is a schematic diagram of a principle of backscatter communication according to some embodiments of the present disclosure;

FIG. 5 is a schematic diagram of a principle of resistance load modulation according to some embodiments of the present disclosure;

FIG. 6 is a flowchart of a wireless communication method according to some embodiments of the present disclosure;

FIG. 7 is a schematic diagram of a wireless communication method according to some embodiments of the present disclosure;

FIG. 8 is a schematic diagram of a wireless communication method according to some other embodiments of the present disclosure;

FIG. 9 is a schematic diagram of a wireless communication method according to some other embodiments of the present disclosure;

FIG. 10 is a schematic diagram of a wireless communication method according to some other embodiments of the present disclosure;

FIG. 11 is a schematic diagram of a wireless communication method according to some other embodiments of the present disclosure;

FIG. 12 is a schematic diagram of a wireless communication method according to some other embodiments of the present disclosure;

FIG. 13 is a schematic diagram of a wireless communication method according to some other embodiments of the present disclosure;

FIG. 14 is a schematic diagram of a wireless communication method according to some other embodiments of the present disclosure;

FIG. 15 is a schematic diagram of a wireless communication method according to some other embodiments of the present disclosure;

FIG. 16 is a schematic diagram of a wireless communication method according to some other embodiments of the present disclosure;

FIG. 17 is a schematic diagram of a wireless communication method according to some other embodiments of the present disclosure;

FIG. 18 is a schematic diagram of a wireless communication method according to some other embodiments of the present disclosure;

FIG. 19 is a schematic diagram of a wireless communication method according to some other embodiments of the present disclosure;

FIG. 20 is a schematic diagram of a wireless communication method according to some other embodiments of the present disclosure;

FIG. 21 is a schematic diagram of a wireless communication method according to some other embodiments of the present disclosure;

FIG. 22 is a schematic diagram of a wireless communication method according to some other embodiments of the present disclosure;

FIG. 23 is a block diagram of a wireless communication apparatus according to some embodiments of the present disclosure;

FIG. 24 is a block diagram of a wireless communication apparatus according to some other embodiments of the present disclosure;

FIG. 25 is a schematic structural diagram of a terminal device according to some embodiments of the present disclosure; and

FIG. 26 is a schematic structural diagram of a network device according to some embodiments of the present disclosure.

### DETAILED DESCRIPTION

For clearer descriptions of the objectives, technical solutions, and advantages of the present disclosure, the embodiments of the present disclosure are further described in detail hereinafter with reference to the accompanying drawings.

The network architecture and service scenarios described in the embodiments of the present disclosure are provided to more clearly illustrate the technical solutions of the embodiments, and do not constitute limitations on the technical solutions offered by these embodiments. As recognized by those of ordinary skill in the art, with the evolution of network architectures and emergence of new service scenarios, the technical solutions provided herein remain applicable to similar technical challenges.

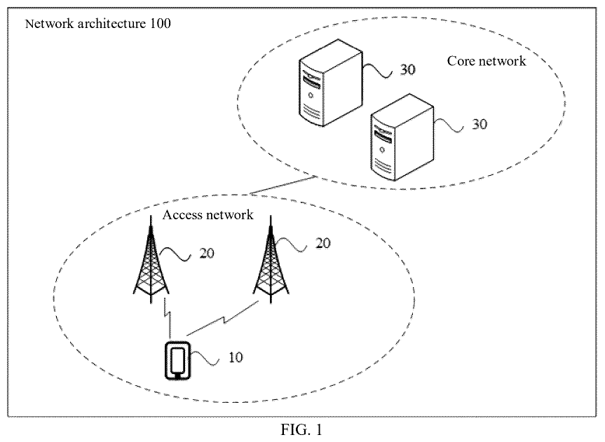

FIG. 1 is a schematic diagram of a network architecture 100 according to some embodiments of the present disclosure. The network architecture 100 may involve a terminal device 10, an access network device 20, and a core network element 30.

The terminal device 10 may be a user equipment (UE), an access terminal, a subscriber unit, a subscriber station, a mobile station, a mobile platform, a remote station, a remote terminal, a mobile device, a wireless communication device, a user agent, or a user apparatus. In some embodiments, the terminal device 10 may also be a cellular phone, a cordless phone, a Session Initiation Protocol (SIP) phone, a wireless local loop (WLL) station, a personal digital assistant (PDA), a handheld device with a wireless communication function, a computing device or another processing device connected to a wireless modem, a vehicle-mounted device, a wearable device, a terminal device in a 5^{th} generation (5G) system, a terminal device in an evolved public land mobile network (PLMN), or the like, which is not limited in the embodiments of the present disclosure. For the convenience of description, the devices mentioned above are collectively referred to as the terminal device. A plurality of terminal devices 10 are usually deployed. At least one terminal device 10 may be distributed in a cell managed by each access network device 20. A terminal device may also be referred to simply as a terminal or UE, and those skilled in the art shall understand its meaning.

The access network device 20 is a device deployed in an access network to provide a wireless communication function for the terminal device 10. The access network device 20 may include various forms of macro base stations, micro base stations, relay stations, access points, and the like. In systems employing different radio access technologies, devices with the function of the access network device may have different names, for example, gNodeB or gNB in a 5G NR system. As the communication technologies evolve, the name “access network device” may change. For the convenience of description, in the embodiments of the present disclosure, the above apparatuses providing the wireless communication function for the terminal device 10 are collectively referred to as the access network device. In some embodiments, a communication relationship may be established between the terminal device 10 and the core network element 30 using the access network device 20. For example, in a long-term evolution (LTE) system, the access network device 20 may be an evolved universal terrestrial radio access network (EUTRAN) or at least one eNodeB in the EUTRAN. In a 5G NR system, the access network device 20 may be a radio access network (RAN) or at least one gNB in the RAN. In the embodiments of the present disclosure, unless otherwise specified, the term “network device” is the access network device 20, e.g., a base station.

The core network element 30 is an element deployed in a core network. The core network element 30 mainly functions to provide a user connection, user management and service bearing, and to provide an interface to an external network as a bearer network. For example, core network elements in the 5G NR system may include elements such as an access and mobility management function (AMF) entity, a user plane function (UPF) entity, and a session management function (SMF) entity.

In some embodiments, the access network device 20 communicates with the core network element 30 using a specific air interface technology, e.g., an NG interface in the 5G NR system. The access network device 20 communicates with the terminal device 10 using a specific air interface technology, e.g., over a Uu interface.

The “5G NR system” in the embodiments of the present disclosure may also be referred to as a 5G system or an NR system, but those skilled in the art may understand its meaning. The technical solutions according to the embodiments of the present disclosure may be applicable to the LTE system, the 5G NR system, an evolved system subsequent to the 5G NR system (e.g., a beyond 5G (B5G) system, or a 6^{th} generation system), a narrowband Internet of things (NB-IoT) system, and other communication systems. This is not limited in the present disclosure.

In the embodiments of the present disclosure, the network device provides services for a cell. The terminal device communicates with the network device over a transmission resource (for example, a frequency-domain resource or a spectrum resource) on a carrier used by the cell. The cell may be a cell corresponding to the network device (for example, the base station). The cell may belong to a macro base station or a base station corresponding to a small cell. The small cell herein may include a metro cell, a micro cell, a pico cell, a femto cell, and the like. These small cells have the characteristics of small coverage and low transmit power, and are applicable to providing high-rate data transmission services.

Prior to description of the technical solutions according to the present disclosure, some relevant technical knowledge involved in the present disclosure is described. The following related arts, as optional solutions, may be arbitrarily combined with the technical solutions according to the embodiments of the present disclosure, and all fall within the protection scope of the embodiments of the present disclosure. The embodiments of the present disclosure include at least part of the following content.

### 1. Zero-Power Communication

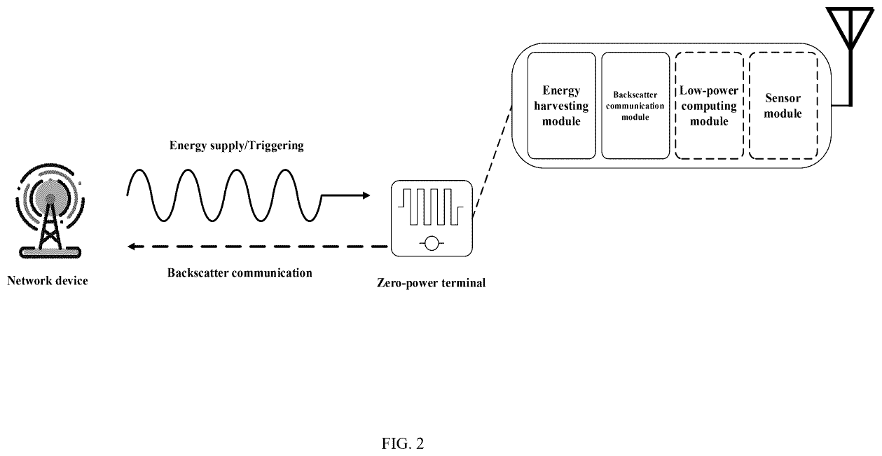

The zero-power communication adopts energy harvesting and backscatter communication technologies. A zero-power communication network involves a network device and a zero-power terminal device, as illustrated in FIG. 2. The network device is configured to transmit wireless power signals and downlink communication signals to the zero-power terminal device, and to receive backscatter signals from the zero-power terminal device. A basic zero-power terminal device includes an energy harvesting module, a backscatter communication module, and a low-power computing module. In addition, the zero-power terminal device may also be provided with a memory or a sensor for storing some basic information such as item identifiers, or acquiring sensing data such as ambient temperature and ambient humidity.

Key technologies of the zero-power communication mainly include RFPH and backscatter communication.

### 1.1 RFPH

As illustrated in FIG. 3, an RFPH module harvests energy from spatial electromagnetic waves by electromagnetic induction, thereby acquiring the energy required to drive the operation of the zero-power terminal device, such as driving a low-power demodulation and modulation module and a sensor and memory reading operation. Therefore, the zero-power terminal device operates without a traditional battery.

### 1.2 Backscatter Communication

As illustrated in FIG. 4, a zero-power terminal device receives a wireless signal from a network device, modulates the wireless signal, loads information to be transmitted, and radiates the modulated signal via an antenna. This information transmission process is referred to as backscatter communication. The functions of backscatter and load modulation are inseparable. The load modulation involves adjusting and controlling circuit parameters of an oscillation circuit of the zero-power terminal device in accordance with a clock rate of a data stream. This causes parameters, such as impedance of an electronic tag, to change accordingly, thereby completing the modulation process. The load modulation technologies mainly support two modes, namely, resistance load modulation and capacitance load modulation. In the resistance load modulation, a load is connected in parallel to a resistor, and the resistor is switched on or off under the control of a binary data stream, as illustrated in FIG. 5. The switching of the resistor causes a change in a voltage of the circuit, thus implementing amplitude shift keying (ASK) modulation. That is, the modulation and transmission of a signal are achieved by adjusting an amplitude of a backscatter signal from the zero-power terminal device. Similarly, in the capacitance load modulation, the switching of a capacitor may cause a change in a resonant frequency of the circuit, thereby implementing frequency shift keying (FSK) modulation. That is, the modulation and transmission of a signal are achieved by adjusting an operating frequency of the backscatter signal from the zero-power terminal device.

In view of the above, the zero-power terminal device implements the backscatter communication process by modulating information onto incoming wave signals via load modulation. Therefore, the zero-power terminal device has the following significant advantages:
(1) The terminal device does not actively transmit signals, and thus does not require complex radio frequency (RF) links, such as a power amplifier (PA) and an RF filter.
(2) The terminal device does not need to actively generate high-frequency signals, and thus does not require a high-frequency crystal oscillator.
(3) By utilizing backscatter communication, signal transmission by the terminal device does not consume the energy of the terminal device.

### 1.3 Encoding

For data transmitted by an electronic tag, a binary “1” and a binary “0” may be represented using different forms of codes. An RF identification (RFID) system typically adopts one of: non-return-to-zero (NRZ) encoding, Manchester encoding, unipolar return-to-zero (URZ) encoding, differential binary phase (DBP) encoding, Miller encoding, or differential encoding. That is, 0 and 1 may be represented using different pulse signals.

### 2. Classification of Zero-Power Terminal Devices

Terminal devices may be classified into the following categories based on energy sources and usage modes of zero-power terminal devices.

### 2.1 Passive Zero-Power Terminal Device

The passive zero-power terminal device does not require a built-in battery. As the zero-power terminal device approaches to a network device (such as a reader/writer of an RFID system), the zero-power terminal device enters a near-field range formed by radiation of an antenna of the network device. Therefore, an antenna of the zero-power terminal device generates an induced current via electromagnetic induction, and the induced current drives a low-power chip circuit of the zero-power terminal device to implement demodulation of signals on a forward link and modulation of signals on a reverse link. For the reverse link, the zero-power terminal device carries out signal transmission via backscattering or low-power active transmission.

In view of the above, the passive zero-power terminal device does not require a built-in battery for driving either the forward link or the reverse link, and thus, the passive zero-power terminal device is a true zero-power device.

The passive zero-power terminal device does not require any battery, and an RF circuit and a baseband circuit of the passive zero-power terminal device are very simple. For example, the passive zero-power terminal device does not require components such as a low-noise amplifier (LNA), a PA, a crystal oscillator, and an analog-to-digital converter (ADC). Therefore, the passive zero-power terminal device has advantages such as small size, light weight, very low cost, and long service life.

The passive zero-power terminal device may also support other energy harvesting methods, and acquire energy to drive the circuit by harvesting energy in the environment (such as light energy, thermal energy, kinetic energy, and mechanical energy) to support the communication of the terminal device.

### 2.2 Semi-Passive Zero-Power Terminal Device

The semi-passive zero-power terminal device is also not equipped with a conventional battery. The semi-passive zero-power terminal device may harvest radio wave energy using an RFPH module or harvest energy in the environment (such as solar energy, thermal energy, and mechanical vibration energy) using an energy harvesting module, and store the harvested energy in an energy storage unit (such as a capacitor). Upon acquiring the energy, the energy storage unit may drive a low-power chip circuit of the zero-power terminal device to perform operations such as demodulation of signals on a forward link and modulation of signals on a reverse link. For the reverse link, the zero-power terminal device carries out signal transmission via backscattering or low-power active transmission.

In view of the above, the semi-passive zero-power terminal device requires no built-in batteries to drive either the forward link or the reverse link. Although the energy stored in the capacitor is used by the semi-passive zero-power terminal device in operation, the energy originates from the radio wave energy harvested by the RFPH module. Therefore, the semi-passive zero-power terminal device is also a true zero-power terminal.

The semi-passive zero-power terminal device inherits advantages of the passive zero-power terminal device, and thus, the semi-passive zero-power terminal device has advantages such as small size, light weight, very low price, and long service life.

### 2.3 Active Zero-Power Terminal Device

The zero-power terminal device used in some scenarios may be an active zero-power terminal device. The active zero-power terminal device may be equipped with a built-in battery. The battery is configured to drive a low-power chip circuit of the zero-power terminal device to implement the demodulation of forward link signals and the modulation of reverse link signals. For the reverse link, the zero-power terminal device carries out signal transmission via backscattering or active transmission. Although the active zero-power terminal device is equipped with a built-in battery, this type of active zero-power terminal device has extremely low power consumption and complexity, and thus, this type of device may be used with a smaller-capacity battery, thereby achieving a small cost and size. The built-in battery may also be used as an energy storage unit for storing ambient energy harvested by the energy harvesting module, thereby achieving a long maintenance cycle, even maintenance-free.

The active zero-power terminal device is powered by the built-in battery to increase the communication range of the zero-power terminal device and improve communication reliability. Therefore, the active zero-power terminal device is suitable for scenarios with relatively high requirements regarding communication range, reading delay, and other aspects.

Some of zero-power terminal devices, such as the semi-passive zero-power terminal device or the active zero-power terminal device, may have active transmission capabilities. That is, for the reverse link, communication may be achieved not only via backscattering but also via active transmission.

### Classification of Zero-Power Terminal Devices Based on Transmitter Types

Service types for zero-power IoT and other types of IoT may primarily focus on uplink services.

### A. Zero-Power Terminal Device Based on Backscattering

Such a zero-power terminal device carries out uplink data transmission using the backscattering method as described above. Such a zero-power terminal device is not equipped with an active transmitter for active transmission but only has a transmitter for backscattering. Therefore, during data transmission, such a zero-power terminal device requires a network device to provide carriers, and performs data transmission via carrier-based backscattering.

### B. Zero-Power Terminal Device Based on Active Transmitter

Such a zero-power terminal device carries out uplink data transmission using an active transmitter with active transmission capabilities. During data transmission, such a zero-power terminal device is able to transmit data using its own active transmitter, without relying on carriers provided by a network device. An active transmitter applicable to such a zero-power terminal device may be an ultra-low-power ASK transmitter, an ultra-low-power FSK transmitter, or the like. Based on current implementations, the overall power consumption of such a transmitter may be reduced to a range from 400 microwatts to 600 microwatts during transmission of a 100-microwatt signal by the transmitter.

### C. Zero-Power Terminal Device With Both Backscattering and Active Transmitter Capabilities

Such a zero-power terminal device supports both backscatter functionality and active transmitter functionality. The terminal device determines whether to perform active transmission using an active transmitter or perform backscattering, depending on different situations (such as different battery levels and different available environment energy sources) or based on scheduling of a network device.

### 3. Cellular Passive IoT

The rapid development of the cellular IoT based on IoT technologies such as narrow band-IoT (NB-IoT), manual toll collection systems, or reduced capabilities (RedCap), which have been standardized in the related art, results in IoT communication requirements across various scenarios remaining unmet. These scenarios are illustrated as follows.

### 3.1 Strict Communication Environment

In some IoT scenarios, devices may be exposed to extreme environmental conditions such as high temperatures, extremely low temperatures, high humidity, high voltage, high radiation, or high-speed motion. Such scenarios include extra-high voltage (EHV) substations, monitoring of high-speed train track, environmental monitoring in polar regions, industrial production lines, and the like. In these scenarios, existing IoT terminals cannot operate due to operating environment restrictions of conventional power supplies. In addition, the extreme operating environment is unfavorable for the maintenance of the IoT terminals, e.g., battery replacement.

### 3.2 Requirements for Ultra-Small Size of Terminals

In some IoT scenarios, such as food traceability, commodity circulation, and smart wearables, a terminal is required to be manufactured with an ultra-small size for convenient use in these scenarios. For example, an IoT terminal is usually in the form of an electronic tag for commodity management in a circulation process, and the IoT terminal is embedded in commodity packaging in a very compact form. For another example, a lightweight wearable device improves user experience while meeting user demands.

### 3.3 Requirements for Ultra-Low-Cost IoT Communication

In numerous IoT communication scenarios, an IoT terminal is required to be produced at sufficiently low cost to enhance competitiveness relative to other alternative techniques. For example, in logistics or warehousing scenarios, an IoT terminal may be attached to each item to facilitate the management of a large volume of items in circulation, thereby achieving precise management of the entire logistics process and lifecycle by means of the communication between the IoT terminal and a logistics network. These scenarios require the price of the IoT terminal to be sufficiently competitive.

With the increase in 5G industry applications, types and application scenarios of connected devices continue to expand, resulting in higher requirements for the price and power consumption of communication terminals. The application of battery-free and low-cost passive IoT devices has become a key technology of the cellular IoT, enriching the types and quantities of terminals connected in the 5G network and truly enabling the Internet of everything.

In the discussion process of standards, the zero-power IoT may also be referred to as an ambient power enabled IoT (abbreviated as ambient IoT), or a passive IoT in some technical literatures. An ambient IoT device refers to an IoT device that is driven by various ambient energies, such as RF energy, light energy, solar energy, thermal energy, mechanical energy, or other ambient energies. Such a device may have no energy storage capability or very limited energy storage capability (such as using a capacitor with a capacity of tens of uF). Compared with conventional IoT devices, the ambient IoT device has advantages such as no need for conventional batteries, maintenance-free, small size, low complexity and low cost, and long life cycle. The ambient IoT device may be widely used in various industries, such as logistics, smart warehousing, smart agriculture, energy and power, and industrial Internet, for vertical industries. The ambient IoT device may also be used to personal applications such as smart wearables and smart homes.

Based on the discussion of application scenarios for ambient IoT by 3^{rd} Generation Partnership Project (3GPP) Standalone (SA1), the ambient IoT is at least applicable to the following four types of scenarios:
object identification, such as logistics management, management of production line products, and supply chain management;
environmental monitoring, such as monitoring of temperature, humidity, and harmful gases in an operating environment and a natural environment;
positioning, such as indoor positioning, intelligent object tracking, and positioning of production line items; and
intelligent control, such as intelligent control of various appliances in smart homes (e.g., turning on/off air conditioners and adjusting temperature) and intelligent control of various facilities in agricultural greenhouses (e.g., automatic irrigation and fertilization).

### 4. Ambient Energy-Based Device (Ambient IoT Device)

In NR systems and wireless fidelity (Wi-Fi) systems, battery-free and low-cost characteristics of devices may support low-cost large-scale deployment and maintenance-free operation of IoT devices. Currently, standards are studying how to support ambient energy-based IoT devices in the NR systems and the Wi-Fi systems. The ambient energy-based IoT devices are referred to as ambient IoT or AMP IoT devices. The energy required for their operation is acquired by ambient energy harvesting from such as wireless signals, solar energy, and thermal energy. These devices are analogous to the passive or semi-passive devices used in the zero-power communication.

In 3GPP RAN, a study item on ambient IoT devices has been conducted, and the ambient IoT devices are categorized into roughly the following three types, each with corresponding complexity and communication capabilities:
Device A, which does not have energy storage capabilities and cannot perform independent signal transmission. That is, the device of this type employs a backscatter transmission mode.
Device B, which has energy storage capabilities but cannot perform independent signal transmission. That is, the device of this type employs a backscatter transmission mode and has capability to amplify backscattered signals using stored energy.
Device C, which has energy storage capabilities and has capabilities to perform independent signal transmission. That is, the device of this type has active transmission capability.

Device A has the lowest complexity and power consumption, with power consumption as low as 1 μW. However, the communication range of this device is limited, typically only a few meters. Device A requires a network device to provide a carrier signal for backscatter transmission. Device C typically has a capacitor with a large capacity to store energy from the environment, and the power consumption of this device may support levels of several hundred μW, enabling active signal transmission and a relatively large communication range. Since Device C has active transmission capability, it does not require a network device to provide a carrier signal. The complexity and power consumption of Device B fall between those of Device A and Device C.

In addition, the ambient energy harvesting supported by zero-power terminals may also include various types of energy, such as RF, solar energy, thermal energy, mechanical energy, and other energies. The zero-power terminals based on RFPH may require the network to provide RF power supply signals.

The ambient IoT device acquires energy for communication by harvesting ambient energy such as RF, solar energy, thermal energy, mechanical energy, and other energies. Compared with conventional terminals with batteries, the communication of the ambient IoT device is affected by its energy state.

Typically, the ambient IoT device alternates between “energy sufficient” and “energy insufficient” states as energy harvesting and signal transmission processes occur. In a case where the energy acquired via ambient energy harvesting is sufficient to support signal transmission, the ambient IoT device is in the “energy sufficient” state. In a case where the remaining energy of the ambient IoT device upon transmitting a signal is insufficient for the next signal transmission, the ambient IoT device is considered to be in the “energy insufficient” state and requires the acquisition of energy for signal transmission via ambient energy harvesting.

The energy harvesting of the ambient IoT device is influenced by various factors, such as energy harvesting efficiency, RF signal strength, energy storage capabilities, terminal types (e.g., differences in communication methods and energy harvesting implementations). Therefore, for different ambient IoT devices deployed in the same cell, the energy harvesting efficiencies may be different due to different distances from an energy supply source, which in turn affects a time interval of signal communication (i.e., a duration required to transition from the “energy insufficient” state to the “energy sufficient” state varies).

In a case where a network device schedules an ambient IoT device for data transmission, communication may fail due to the unknown energy state of the ambient IoT device. For example, the network device fails to determine whether the ambient IoT is in an “energy sufficient” state, but still schedules the ambient IoT device to transmit data with a transport block size (TBS) of X. However, the ambient IoT device has limited energy, insufficient to support data transmission with a TBS of X.

In another case where an ambient IoT device consistently transmits signals using the total energy P harvested within a period of time T, signal transmission may fail due to a non-cooperative communication mode with a network device. In this case, due to the low energy harvesting efficiency of the device, the time required to re-enter the “energy sufficient” state is relatively long, which increases the communication delay.

Therefore, a communication mechanism design is necessary for ambient IoT devices to efficiently use the harvested energy for communication, reduce communication failures caused by non-cooperation between ambient IoT devices and network devices, and reduce communication delay.

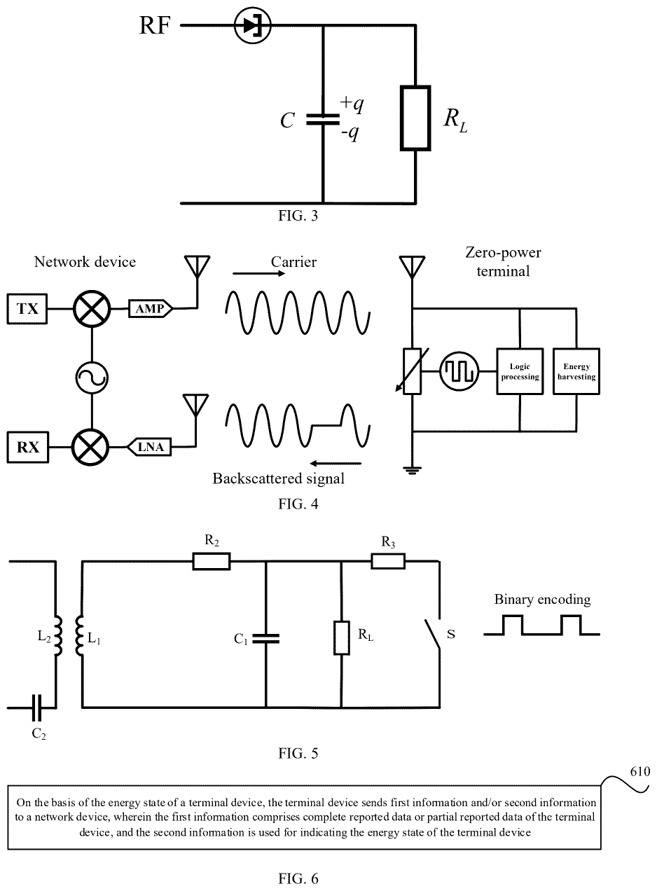

FIG. 6 is a flowchart of a wireless communication method according to some embodiments of the present disclosure. The method is applicable to the network architecture illustrated in FIG. 1, and the method is performed by a terminal device. The method may include the following step 610.

In step 610, the terminal device transmits at least one of first information or second information to a network device based on an energy state of the terminal device, wherein the first information includes complete report data or partial report data of the terminal device, and the second information is used to indicate the energy state of the terminal device.

In some embodiments, the complete report data includes all the data required for a complete communication service. Exemplarily, the terminal device, as an ambient IoT device for environmental monitoring, needs to transmit environmental monitoring data (e.g., temperature, humidity, vibration frequency, etc.), geographic location, time, or the like, to the network device. All report data may be transmitted to the network device via one data transmission (i.e., the transmission of the first information).

In some embodiments, the partial report data includes part of the data required for a complete communication service. Exemplarily, all report data may be transmitted to the network device via a plurality of data transmission processes. The data transmission refers to the transmission of the first information. The data transmission process involves, for example, first transmitting position and time information, followed by actual measurements.

In some embodiments, the terminal device being in an energy sufficient state means that the energy of the terminal device is sufficient to support a complete service communication, and the complete service communication may involve one or more data transmissions. That is, the energy of the terminal device supports the transmission of the first information once or several times.

In some embodiments, the terminal device being in an energy sufficient state means that the energy of the terminal device is sufficient to support one data transmission in a complete service communication. That is, the energy of the terminal device supports the transmission of the first information once.

In some embodiments, for an ambient IoT device that is in a consistently “energy sufficient” state, data reporting may be periodically performed, that is, signals may be periodically transmitted. For example, by using a backscatter communication mode, ambient energy harvesting supports real-time communication needs of the terminal device, providing the terminal device with relatively sufficient energy for communication.

In some other embodiments, for an ambient IoT device that fails to maintain a consistently “energy sufficient” state, in a case where communication is performed using energy harvested based on ambient energy, upon completion of one data transmission or K instances of data interaction, this device enters an “energy insufficient” state and is unable to perform communication, and requires a period of T to harvest the ambient energy for the next data transmission.

In some embodiments, whether the terminal device is in an energy sufficient state is determined based on a threshold.

The energy state of the terminal device is represented by the amount of energy harvested by the terminal device.

In some embodiments, the energy state of the terminal device may be reflected by the energy of the terminal device, or by whether the energy of the terminal device reaches a threshold, which is not limited in the present disclosure.

In some embodiments, one or more thresholds may be configured, which is not limited in the present disclosure.

Exemplarily, the terminal device corresponds to one threshold, which is referred to as a first threshold. In a case where the energy of the terminal device is greater than or equal to the first threshold, the terminal device is in an energy sufficient state; and in a case where the energy of the terminal device is less than the first threshold, the terminal device is in a low-energy state.

Exemplarily, the terminal device corresponds to a plurality of thresholds. For example, the terminal device corresponds to three thresholds: threshold 1, threshold 2, and threshold 3.In a case where the energy of the terminal device is greater than or equal to threshold 1, the energy of the terminal device is sufficient to support the transmission of the first information including data 1. In a case where the energy of the terminal device is greater than or equal to threshold 2, the energy of the terminal device is sufficient to support the transmission of the first information including data 2. In a case where the energy of the terminal device is greater than or equal to threshold 3, the energy of the terminal device is sufficient to support the transmission of the first information including data 3. Herein, 0<threshold 1<threshold 2<threshold 3.

In some embodiments, the terminal device corresponds to a plurality of thresholds, wherein the plurality of thresholds have mapping relationships with transmission formats of the first information. Exemplarily, the first information is configured with a long format and a short format, wherein threshold 1 has a mapping relationship with the long format, and threshold 2 has a mapping relationship with the short format.

In some embodiments, the configuration of the transmission format of the first information is not limited in the present disclosure. Exemplarily, different transmission formats may be configured by referencing the design of physical random access channel (PRACH). For example, the first information in format 1 is used for K1 repeated transmissions of to-be-transmitted data, and the first information in format 2 is used for K2 repeated transmissions of the to-be-transmitted data, wherein K1 is not equal to K2, and K1 and K2 are positive integers. Exemplarily, different transmission formats may be configured based on different TBSs. For example, the first information in format 1 supports a TBS that is greater than x1 and less than x2, and the first information in format 2 supports a TBS that is greater than x3 and less than x4.

In some embodiments, a plurality of pieces of first information in different transmission formats may correspond to the same threshold or different thresholds, which is not limited in the present disclosure.

In some embodiments, the threshold may be determined based on terminal implementation, predefined or preconfigured, or configured by the network device, which is not limited in the present disclosure.

In some embodiments, the threshold may be determined based on the energy required to transmit the first information. In a case where the terminal device corresponds to one threshold (i.e., the first threshold), the first threshold may be a maximum value of the energy required by the terminal device to transmit the first information. Exemplarily, in a case where a complete service communication only includes one data transmission, the first threshold may indicate the energy required for this data transmission. Exemplarily, in a case where a complete service communication includes at least two data transmissions, the first threshold may be a maximum value of the energy required for each of the two data transmissions. In a case where the terminal device corresponds to a plurality of thresholds, and a complete service communication includes at least two data transmissions, each of the at least two data transmissions corresponds to a threshold, which is a value of energy required for the corresponding data transmission.

In some embodiments, the second information may implicitly indicate the energy state of the terminal device or explicitly indicate the energy state of the terminal device, which is not limited in the present disclosure.

In some embodiments, the second information includes at least one of: common information, random access information, identification information of the terminal device, or sequence information.

In some embodiments, the common information refers to information shared by a plurality of terminal devices. Exemplarily, for environmental monitoring in a particular area, a plurality of ambient IoT devices may be deployed in the area for environmental monitoring, and a plurality of pieces of second information transmitted by these environmental monitoring devices are all common information. That is, the plurality of pieces of second information transmitted by different ambient IoT devices are the same.

In some embodiments, the random access information refers to information related to random access of the terminal device. For example, the random access information may be a random access preamble, such as msg1 in a four-step random access procedure. For another example, the random access information may be msgA in a two-step random access procedure.

In some embodiments, the identification information of the terminal device is used to uniquely identify the terminal device. Exemplarily, the identification information of the terminal device may be a UE-specific signal of the terminal device. Exemplarily, the identification information of the terminal device may be a device identity document (ID) of the terminal device.

In some embodiments, the sequence information refers to information in the form of a sequence. Exemplarily, the second information may be a short sequence, such that the energy required to transmit the second information is less.

In some embodiments, a length of a time-domain resource occupied by the second information is less than a length of a time-domain resource occupied by the first information.

In some embodiments, the energy required to transmit the second information is less than the energy required to transmit the first information.

In some embodiments, frequency-domain resources occupied by the first information and the second information may be the same or different. Exemplarily, the frequency domain resources occupied by the first information and the second information are in different bands. For example, the terminal device transmits the second information on a dedicated band for the second information.

In some embodiments, the time-frequency domain resources occupied by the second information are associated with the time-frequency domain resources occupied by the first information. For example, the network device may determine the time-frequency domain resources occupied by the first information based on the time-frequency domain resources occupied by the second information, and receive the first information on the determined time-frequency domain resources. In this case, no blind detection is required for the network device, thereby saving the power consumption of the network device.

In some embodiments, the second information is a first reference signal, and the first reference signal is used to identify or indicate the transmission of the first information. Exemplarily, upon detecting the second information, the network device determines that the terminal device transmits the first information, and the network device receives the first information based on the second information. In a case where the network device fails to detect the second information, the network device determines that no first information is transmitted by the terminal device, and the network device does not need to receive the first information.

In some embodiments, the second information is used to directly or indirectly indicate a transmission configuration of the first information, or used to determine a transmission configuration of the first information. The second information is used to indicate at least one of a code rate, a coding scheme, or a time-domain length.

In some embodiments, a time interval is present between the first information and the second information.

In some embodiments, the terminal device does not transmit the first information within a first time interval following the transmission of the second information, wherein the first time interval is a minimum time interval between transmission of the first information and transmission of the second information.

In some embodiments, the terminal device transmits the first information within a second time interval following transmission of the second information, wherein the second time interval is a maximum time interval between transmission of the first information and transmission of the second information.

In some embodiments, the terminal device may randomly select a moment within a window between a first moment and a second moment, both following transmission of the second information, to transmit the first information. A time interval between the first moment and a moment of transmitting the second information is referred to as the first time interval. A time interval between the second moment and the moment of transmitting the second information is referred to as the second time interval.

In some embodiments, the terminal device may transmit the first information at the first moment following transmission of the second information.

In some embodiments, the terminal device may transmit the first information at the second moment following transmission of the second information.

In some embodiments, the terminal device transmits the first information at a third moment following transmission of the second information. In some embodiments, a time interval between the third moment and the moment of transmitting the second information is fixed and is between the first moment and the second moment.

Values of the first time interval and the second time interval are not limited in the present disclosure. Exemplarily, the first time interval may be determined based on the communication delay between the terminal device and the network device, and the second time interval may be determined based on a speed at which the terminal device harvests energy.

In some embodiments, the first time interval, the second time interval, and the third moment may be determined based on the terminal implementation, configured by the network device, or predefined or preconfigured, which is not limited in the present disclosure.

In the technical solutions according to the embodiments of the present disclosure, at least one of the first information or the second information is transmitted to the network device based on the energy state of the terminal device. Transmission of the first information to the network device based on the energy state of the terminal device ensures that the data contained in the first information is parseable by the network device, thereby avoiding transmission failures, and thus preventing any impact on the communication quality between the terminal device and the network device. Transmission of the second information to the network device based on the energy state of the terminal device allows the network device to determine, based on the second information, whether the terminal device transmits the first information, and then determine whether to receive the first information, and thus the network device does not need to perform continuous blind detection, such that the power consumption of the network device is reduced.

The cases where the terminal device corresponds to one threshold and the terminal device corresponds to a plurality of thresholds are exemplarily introduced hereinafter.

Case 1: The terminal device corresponds to one threshold (i.e., the first threshold).

Case 1.1: In response to the energy of the terminal device being greater than or equal to the first threshold, the terminal device transmits at least one of the first information or the second information to the network device.

In some embodiments, in response to the energy of the terminal device being greater than or equal to the first threshold, the terminal device directly transmits the first information to the network device. Exemplarily, as illustrated in FIG. 7, in response to the energy of the terminal device being greater than or equal to threshold X, the terminal device directly transmits the first information 110 to the network device.

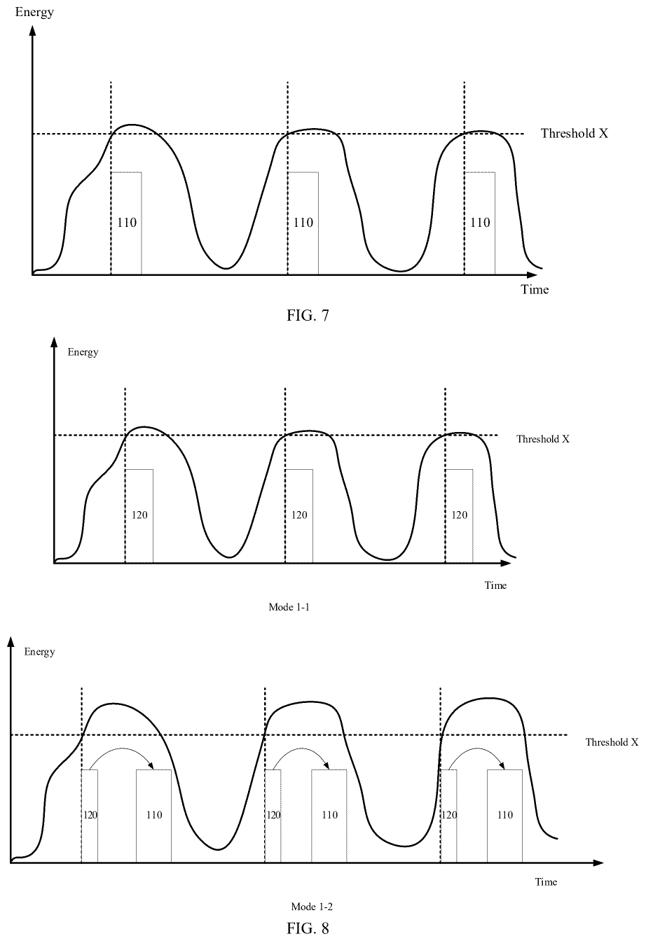

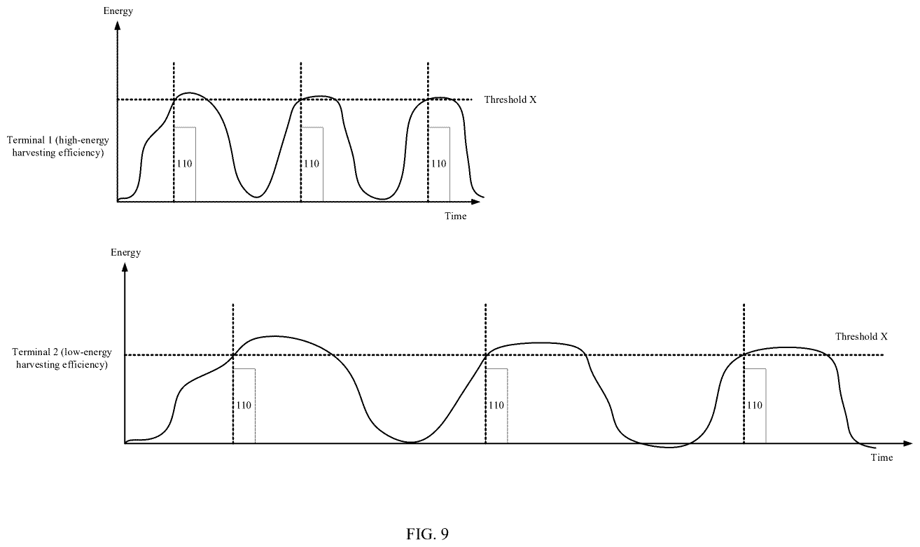

In some embodiments, in response to the energy of the terminal device being greater than or equal to the first threshold, the terminal device directly transmits the second information to the network device. Exemplarily, as illustrated in Mode 1-1 of FIG. 8, in response to the energy of the terminal device being greater than or equal to threshold X, the terminal device directly transmits the second information 120 to the network device.

In some embodiments, in response to the energy of the terminal device being greater than or equal to the first threshold, the terminal device directly transmits the first information and the second information to the network device.

In some embodiments, in response to the energy of the terminal device being greater than or equal to the first threshold, the terminal device directly transmits the second information to the network device, and transmits the first information to the network device upon elapse of a fourth time interval following transmission of the second information.

In some embodiments, the fourth time interval is greater than or equal to the first time interval and less than or equal to the second time interval.

In some embodiments, the fourth time interval may be determined based on the terminal implementation, configured by the network device, or predefined or preconfigured, which is not limited in the present disclosure.

As illustrated in Mode 1-2 of FIG. 8, in response to the energy of the terminal device being greater than or equal to threshold X, the terminal device directly transmits the second information 120 to the network device, and transmits the first information 110 to the network device upon elapse of a time interval following transmission of the second information 120.

Case 1.2: Within a first time period following the energy of the terminal device reaching the first threshold, the terminal device transmits at least one of the first information or the second information to the network device.

In some embodiments, within a first time period following the energy of the terminal device reaching the first threshold, the terminal device randomly determines a moment to transmit at least one of the first information or the second information to the network device.

In some embodiments, within a first time period following the energy of the terminal device reaching the first threshold, the terminal device randomly determines a moment to transmit the second information to the network device, and transmits the first information to the network device upon elapse of a fourth time interval following transmission of the second information.

In some embodiments, in a case where the terminal device transmits the first information upon elapse of the fourth time interval following transmission of the second information to the network device, the moment of transmitting the first information may or may not fall within the first time period, which is not limited in the present disclosure.

In some embodiments, the first time period may be determined based on the terminal implementation, configured by the network device, or predefined or preconfigured, which is not limited in the present disclosure.

By adopting the above method, in a case where a plurality of terminal devices are located in the same deployed cell, the randomized determination of transmission timing may stagger the transmission timing of the plurality of terminal devices. This prevents data collision during transmission, thereby avoiding transmission failures.

Case 1.3: Upon elapse of a second time period following the energy of the terminal device reaching the first threshold, the terminal device transmits at least one of the first information or the second information to the network device.

In some embodiments, upon elapse of a second time period following the energy of the terminal device reaching the first threshold, the terminal device randomly determines a moment to transmit at least one of the first information or the second information to the network device.

In some embodiments, within a second time period following the energy of the terminal device reaching the first threshold, the terminal device randomly determines a moment to transmit the second information to the network device, and transmits the first information to the network device upon elapse of a fourth time interval following transmission of the second information.

In some embodiments, the second time period may be determined based on the terminal implementation, configured by the network device, or predefined or preconfigured, which is not limited in the present disclosure.

In some embodiments, the second time period may be randomly determined.

In some embodiments, the second time periods corresponding to different terminal devices may be the same or different, which is not limited in the present disclosure.

By adopting the above method, in a case where a plurality of terminal devices are located in the same deployed cell, the randomized determination of transmission timing may stagger the transmission timing of the plurality of terminal devices. This prevents data collision during transmission, thereby avoiding transmission failures.

Case 2: The terminal device corresponds to a plurality of thresholds.

In some embodiments, in response to the energy of the terminal device being greater than or equal to an i^{th} threshold, the terminal device transmits the first information in a j^{th} format or the second information to the network device, i and j being positive integers, wherein the first information in each format or the second information corresponds to a threshold.

In some embodiments, the first information in each format corresponds to a threshold, and the second information also corresponds to a threshold. Exemplarily, the second information corresponds to threshold 1, the first information in format 1 corresponds to threshold 2, and the first information in format 2 corresponds to threshold 3. In response to the energy of the terminal device being greater than or equal to threshold 1, the terminal device transmits the second information to the network device. In response to the energy of the terminal device being greater than or equal to threshold 2, the terminal device transmits the first information in format 1 to the network device. In response to the energy of the terminal device being greater than or equal to threshold 3, the terminal device transmits the first information in format 2 to the network device.

In some embodiments, the first information in each format corresponds to a threshold. Exemplarily, the first information in format 1 corresponds to threshold 1, and the first information in format 2 corresponds to threshold 2. In response to the energy of the terminal device being greater than or equal to threshold 1, the terminal device transmits the first information in format 1 and the second information to the network device. In response to the energy of the terminal device being greater than or equal to threshold 2, the terminal device transmits the first information in format 2 and the second information to the network device.

In some embodiments, the second information corresponding to the first information in different formats may be the same or different.

In some embodiments, the second information may be used to indicate the format of the first information transmitted by the terminal device.

By adopting the above method, the terminal device may flexibly select the transmission timing of the first information to the network device and the format of the first information.

Determining whether to transmit the first information based on the energy state of the terminal device is a straightforward implementation. However, in the same deployed cell, various factors such as energy harvesting efficiency, energy harvesting implementation, power supply signal strength, and a distance from a power supply signal source may lead to different cold-start and warm-start times of the terminal device. Herein, the warm-start time refers to a duration required for a device to acquire sufficient energy for the next communication via ambient energy harvesting, following completion of a previous communication. Exemplarily, FIG. 9 is a frequency schematic diagram of the transmission of the first information 110 by two terminal devices (terminal 1 and terminal 2) with different energy harvesting efficiencies. A cold start of a terminal device refers to the first instance of service communication performed by the terminal device, or the first transmission of at least one of the first information or the second information by the terminal device. A warm start of a terminal device refers to the first instance of service communication by the terminal device in a case where the terminal device has been powered on, wherein the terminal device has performed service communication prior to the current power-on. The cold start and warm start of the terminal device may be analogized to an initial random access procedure and a cell handover procedure.

Therefore, the time intervals for data reporting by ambient IoT devices deployed in the same cell are different. The terminal device transmits the first information in a case where the terminal device is in an energy sufficient state. This behavior is unpredictable for the network device (as the network device is unable to anticipate the transmission timing of the first information by the terminal device), necessitating continuous blind detection by the network device.

In a case where the terminal device performs transmission of the first information and the second information, the network device may first detect the second information, wherein the second information is used to indicate whether the network device needs to detect the first information. Once the second information is detected, the network device determines that the terminal device has transmitted the first information, and then receives the first information based on the second information. Otherwise, in a case where the network device fails to detect the second information, the network device determines that the terminal device has not transmitted the first information and does not need to receive the first information. The detection complexity, power consumption, time-frequency resources, bandwidth, etc. of the second information are different from those of the first information. For example, the second information may have lower detection complexity and power consumption. Consequently, the network device may avoid frequent blind detection of the first information.

Other embodiments are introduced hereinafter by using an example where the terminal device corresponds to one threshold (i.e., the first threshold). The content in the following embodiments may also be combined with the embodiments where the terminal device corresponds to a plurality of thresholds to form new technical solutions. Such new technical solutions should also fall within the protection scope of the embodiments of the present disclosure.

In a case where the transmission of the first information is determined solely based on the energy state, the position of the first information in the time domain is completely random, which is not conducive to the network device performing blind detection. In some embodiments, determining a transmission range of the first information in the time domain may facilitate the reception of the first information by the network device.

Therefore, an ambient IoT device performing signal transmission may determine a time-domain position for transmitting the first information in combination with a reference signal.

In some embodiments, the method further includes the following step 620 (not shown).

In step 620, the terminal device receives a second reference signal, wherein the second reference signal is used to instruct the terminal device to transmit the first information.

In some embodiments, the second reference signal is periodic.

In some embodiments, the second reference signal may be one of: a beacon signal in a Wi-Fi scenario, a synchronization signal and physical broadcast channel (PBCH) block (SSB) signal in a cellular network, or a signal dedicated to an ambient IoT device.

In some embodiments, the second reference signal is transmitted by at least one of the network device or a third-party device. The third-party device is a device other than the network device and the terminal device.

In some embodiments, the third-party device may include at least one of a terminal device other than the aforementioned terminal device, a network device other than the aforementioned network device, a core network device, or a server.

In some embodiments, in a case where the second reference signal is transmitted by a third-party device, the network device receives the second reference signal.

In some embodiments, the third-party device establishes synchronization with the network device.

In some embodiments, a period for the third-party device to transmit the second reference signal is configured by the network device.

In some embodiments, the second reference signal is used to indicate a time-domain resource for the terminal device to transmit the first information.

In some embodiments, the second reference signal is used to indicate a time-domain resource for the terminal device to transmit the second information.

In some embodiments, the network device performs blind detection on the time-domain resource indicated by the second reference signal.

In some embodiments, the terminal device determines a time-domain resource for transmitting at least one of the first information or the second information based on the second reference signal and a first offset value. The first offset value refers to a time offset between a moment of transmitting at least one of the first information or the second information and a moment of transmitting the second reference signal.

In some embodiments, the first offset value may be configured by the network device, or predefined or preconfigured, which is not limited in the present disclosure.

In some embodiments, in response to the energy of the terminal device being greater than or equal to the first threshold, the terminal device receives the second reference signal and determines the time-domain resource for transmitting at least one of the first information or the second information based on the second reference signal. Exemplarily, as illustrated in FIG. 10, the energy of the terminal device exceeds threshold X at time t1, the terminal device receives the second reference signal 130 at time t2, and determines to transmit the first information 110 at time t3 based on the second reference signal 130.

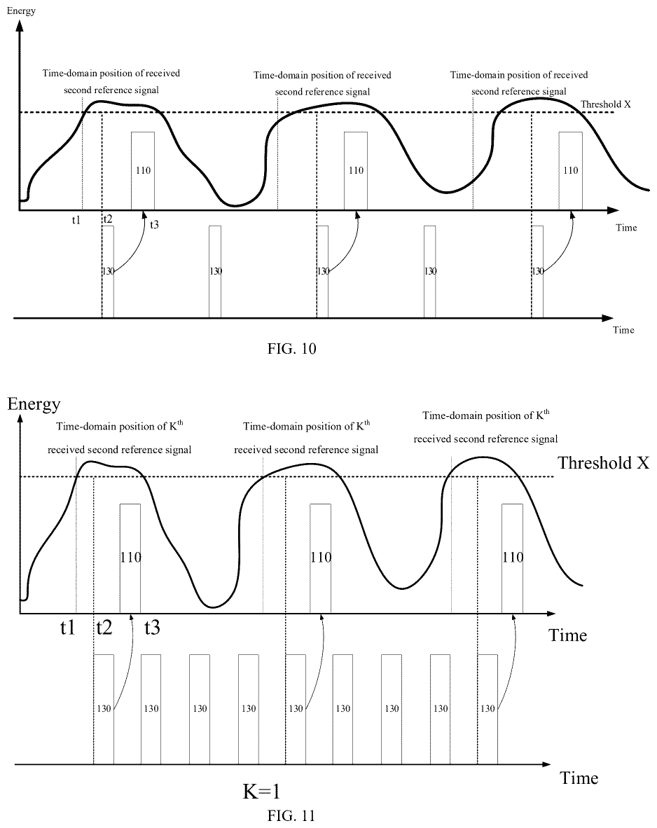

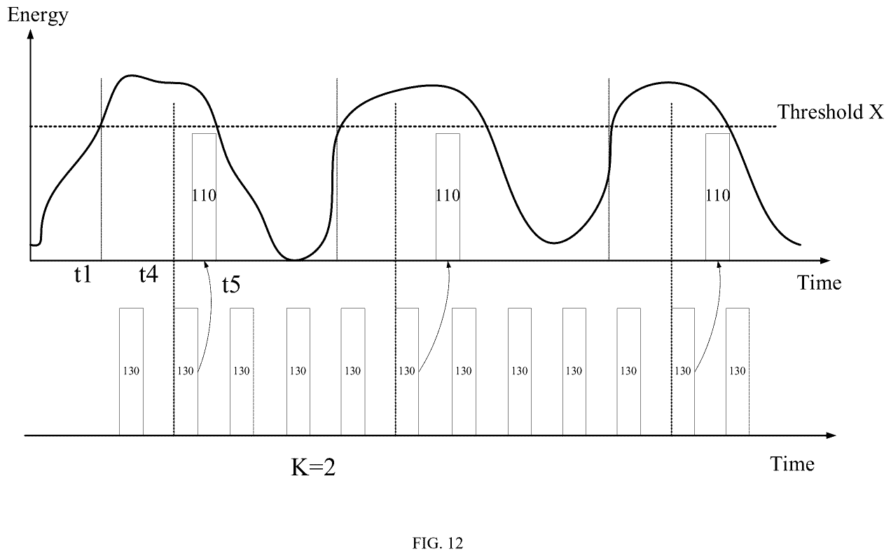

In some embodiments, in response to the energy of the terminal device reaching the first threshold, the terminal device determines the time-domain resource for transmitting at least one of the first information or the second information based on the 1^{st} second reference signal received. Exemplarily, as illustrated in FIG. 11, the energy of the terminal device reaches threshold X at time t1, the terminal device receives the 1^{st} second reference signal 130 at time t2, and then the terminal device determines to transmit the first information 110 at time t3 based on the second reference signal 130.

In some embodiments, in response to the energy of the terminal device reaching the first threshold, the terminal device determines the time-domain resource for transmitting at least one of the first information or the second information based on a Kth second reference signal received, wherein K is a positive integer.

In some embodiments, a value of K may be configured by the network device, or predefined or preconfigured.

In some embodiments, the values of K corresponding to different terminal devices may be the same or different, which is not limited in the present disclosure.

Exemplarily, as illustrated in FIG. 12, K is equal to 2, the energy of the terminal device reaches threshold X at time t1, the terminal device receives the 2^{nd} second reference signal 130 at time t4, and then the terminal device determines to transmit the first information 110 at time t5 based on the second reference signal 130.

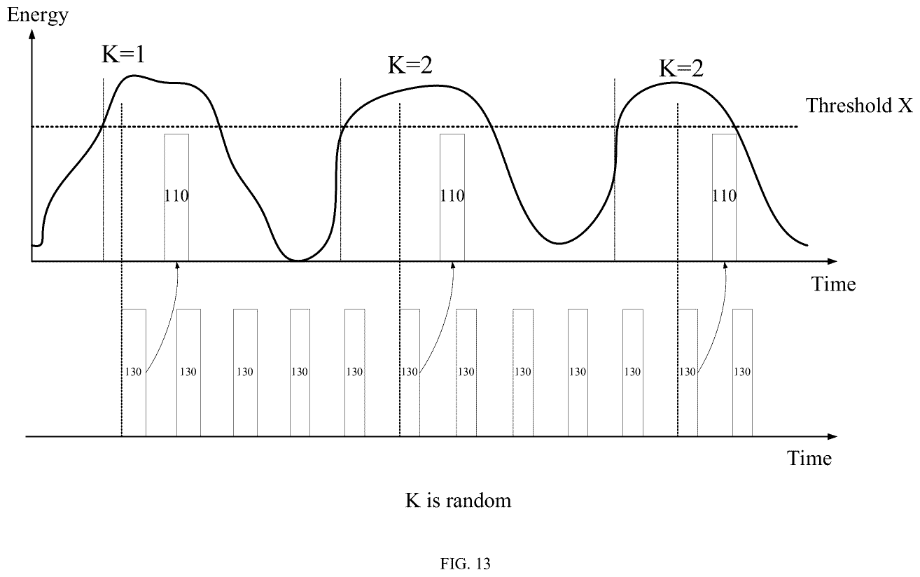

In some embodiments, the value of K is determined based on the terminal implementation. Exemplarily, the value of K may be randomly determined by the terminal device. Exemplarily, as illustrated in FIG. 13, in response to the energy of the terminal device reaching threshold X for the first time, the terminal device determines the time-domain resource for transmitting at least one of the first information 110 or the second information (not shown) based on the 1^{st} second reference signal 130 received; and in response to the energy of the terminal device reaching threshold X for the second time, the terminal device determines the time-domain resource for transmitting at least one of the first information 110 or the second information (not shown) based on the 2^{nd} second reference signal 130 received.

In some embodiments, the value of K is within a first value range. In some embodiments, the first value range may be configured by the network device, or predefined or preconfigured, which is not limited in the present disclosure.

In some embodiments, a minimum value in the first value range is 1.

In some embodiments, the terminal device uses the time-domain position (resource) determined based on the second reference signal to transmit the second information.

In some embodiments, the second information is used to indicate the time-frequency domain resource for the terminal device to transmit the first information, and the network device receives the first information based on the time-frequency domain resource indicated by the second information.

In some embodiments, the terminal device uses the time-domain position (resource) determined based on the second reference signal to transmit the first information.

By adopting the above method, the network device only needs to perform blind detection on the time-frequency domain resource indicated by the second reference signal, without continuous blind detection. In addition, in a case where the time-frequency domain resource, indicated by the second reference signal, is used to transmit the second information, the complexity, power consumption, etc. of the network device for blind detection is reduced.

In a case where the terminal device is in a state of sufficient energy, the terminal device has the signal transmission capability. However, directly using this energy for communication without network coordination results in uncertainty regarding whether the network device have received data. Therefore, an approach may be considered where less energy is used to transmit third information to notify the network device that the terminal device is in a communicable state, and used to monitor the scheduling of the network device and perform communication based on the scheduling of the network device.

In this way, since the energy required to transmit the third information is less than that for the first information, the terminal device, upon transmitting the third information, may acquire energy greater than the first threshold for the next transmission of the first information via ambient energy harvesting in a shorter time, compared to transmitting the first information.

In some embodiments, the method further includes at least one of the following steps 630 and 640 (not shown).

In step 630, the terminal device transmits third information to the network device based on the energy state of the terminal device, wherein the third information is used to request transmission of the first information.

In some embodiments, the third information includes at least one of a common sequence or identification information of the terminal device.

In some embodiments, the common sequence refers to a sequence shared by a plurality of terminal devices.

In some embodiments, in response to the energy of the terminal device being greater than or equal to the first threshold, the terminal device transmits the third information to the network device.

In some embodiments, within a third time period following the energy of the terminal device reaching the first threshold, the terminal device transmits the third information to the network device.

In some embodiments, upon elapse of a fourth time period following the energy of the terminal device reaching the first threshold, the terminal device transmits the third information to the network device.

In some embodiments, the third time period may be the same as or different from the first time period, which is not limited in the present disclosure.

In some embodiments, the fourth time period may be the same as or different from the second time period, which is not limited in the present disclosure.

In some embodiments, the third time period and the fourth time period may be configured by the network device, determined by the terminal device based on the implementation of the terminal device, or predefined or preconfigured, which is not limited in the present disclosure.

In some embodiments, the third information is used to indicate at least one of energy harvesting efficiency of the terminal device or capabilities supported by the terminal device.

In some embodiments, the common sequence may be of a plurality of types, with different types respectively associated with different capabilities of the terminal device. Exemplarily, a first sequence is associated with high-energy harvesting efficiency and a short transmission interval capability; and a second sequence is associated with low-energy harvesting efficiency and a long transmission interval capability. Exemplarily, the first sequence is associated with a capability of the terminal device to support the first information in a long format, such as a time domain length>T0; and the second sequence is associated with a capability of the terminal device to support the first information in a short format, such as a time domain length<T0. T0 is a positive number. T0 may be configured by the network, or predefined or preconfigured, which is not limited in the present disclosure.

In some embodiments, a band occupied by the third information may be the same as or different from a band occupied by the first information and/or the second information, which is not limited in the present disclosure.

In some embodiments, a time-frequency domain resource occupied by the third information may be associated with a time-frequency domain resource occupied by the first information.

In some embodiments, a time-frequency domain resource occupied by the third information may be associated with a time-frequency domain resource occupied by the second information.

In step 640, the terminal device receives a third reference signal from the network device, wherein the third reference signal is used to instruct the terminal device to transmit the first information.

In some embodiments, the third reference signal is used to indicate the time-frequency domain resource for the terminal device to transmit at least one of the first information or the second information. In some embodiments, the third reference information is used to indicate a transmission configuration of the first information.

In some embodiments, the terminal device periodically transmits the third information until the terminal device receives the third reference signal from the network device.

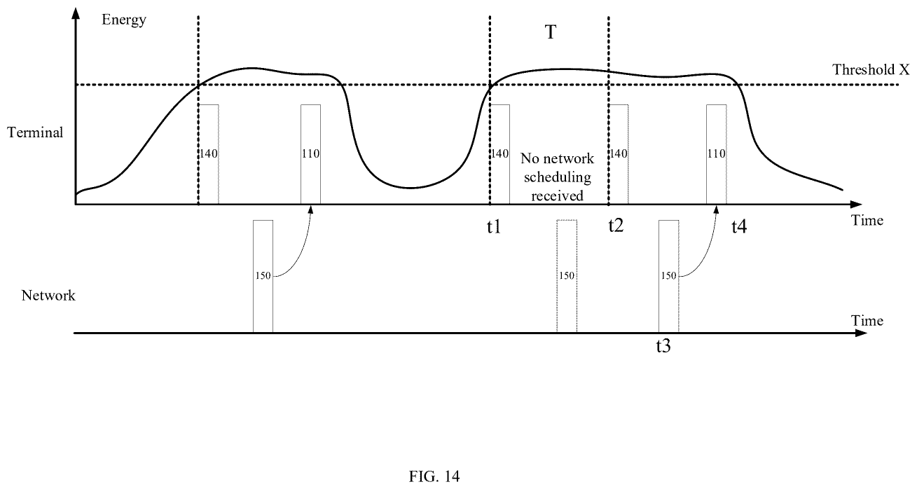

Exemplarily, as illustrated in FIG. 14, the terminal device transmits the third information 140 to the network device at time t1. In a case where the terminal device does not receive the third reference signal 150 from the network device within time interval T, the terminal device transmits the third information 140 to the network device again at time t2. In a case where the terminal device receives the third reference signal 150 from the network device at time t3, the terminal device determines to transmit the first information 110 to the network device at time t4 based on the third reference signal 150.

By adopting the above method, the terminal device may transmit data upon establishment of communication with the network device, and the network device may determine the time-frequency domain resource position where the terminal device transmits the first information, thereby preventing data transmission failures.

The embodiments described above relate to a communication mode in which the terminal device actively reports data, primarily targeting application scenarios such as environmental monitoring. In such scenarios, upon acquiring sufficient energy for communication services based on ambient energy, the terminal device may directly report data, or may report data in combination with a reference signal, or may report data based on the scheduling of the network device by transmitting a request signal.

In other application scenarios, such as positioning and asset inventory, the network device typically schedules the terminal device for communication. In a case where the network device directly schedules the terminal for communication, the terminal device may be unable to perform data transmission due to limitations in the energy state of the terminal device. In this case, designing a method for the network device to schedule an ambient IoT device for communication is necessary.

Ambient IoT devices receiving scheduling information from a network device, support different signal transmission methods depending on their energy states. In a case where the terminal device is in an energy sufficient state, the device may support signal transmission with a relatively long duration, such as supporting a communication duration of T1. In a case where the terminal device is in a low-energy state, the device may only support signal transmission with a relatively short duration, such as supporting a communication duration of T2, wherein T2<T1. In a case where the terminal device is in an extremely energy shortage state, the device may only transmit a signal in a short sequence/short format, such as supporting a communication duration of T3, wherein T3<T2<T1. Herein, T1, T2, and T3 are all positive numbers.

In some embodiments, the method further includes the following step 650 (not shown).

In step 650, the terminal device receives scheduling information from the network device, wherein the scheduling information is used to instruct the terminal device to transmit the first information.

In some embodiments, the network device transmits scheduling information to the terminal device. However, the terminal device is limited by the energy state, resulting in two scenarios: “being capable of performing a complete data transmission” and “being unable to perform a complete data transmission.”

The “being capable of performing a complete data transmission” refers to a scenario where, by using the energy acquired based on ambient energy harvesting, the terminal device is capable of transmitting the first information based on the scheduling of the network device over a time-frequency resource scheduled by the network device for communication, wherein the first information includes complete report data. The “being unable to perform a complete data transmission” refers to a scenario where, by using the energy acquired based on ambient energy harvesting, the terminal device transmits the first information over a time-frequency resource scheduled by the network device for communication, wherein the first information includes partial report data.

Exemplarily, the network device schedules the terminal device to transmit data over a time-domain resource with a duration of T1. However, the terminal device is only capable of transmitting data over a time-domain resource with a duration of T2, wherein T2<T1. This is referred to as the scenario “being unable to perform a complete data transmission.”

For the above example, serval solutions are provided hereinafter according to the embodiments of the present disclosure.

Solution 1: In response to the energy of the terminal device being greater than or equal to the first threshold, the terminal device transmits at least one of the first information or the second information to the network device, wherein the first information includes the complete report data of the terminal device.

Solution 2: In response to the energy of the terminal device being less than the first threshold, the terminal device does not transmit the first information and the second information to the network device.

Solution 3: In response to the energy of the terminal device being less than the first threshold, the terminal device transmits the first information to the network device, wherein the first information includes partial report data of the terminal device.

Solution 4: In response to the energy of the terminal device being less than the first threshold, the terminal device transmits the second information to the network device, wherein the second information is used to identify or indicate or associate information related to the first information.

Solution 5: In response to the energy of the terminal device being less than the first threshold, the terminal device transmits at least one of the first information or the second information to the network device, wherein the first information includes partial report data of the terminal device.

In some embodiments, solution 1 may be combined with one or more of the other four solutions to form a new solution.

Exemplarily, solution 1 is combined with solution 2. In response to the energy of the terminal device being greater than or equal to the first threshold, the terminal device transmits at least one of the first information or the second information to the network device, wherein the first information includes the complete report data of the terminal device; and in response to the energy of the terminal device being less than the first threshold, the terminal device does not transmit the first information and the second information to the network device.

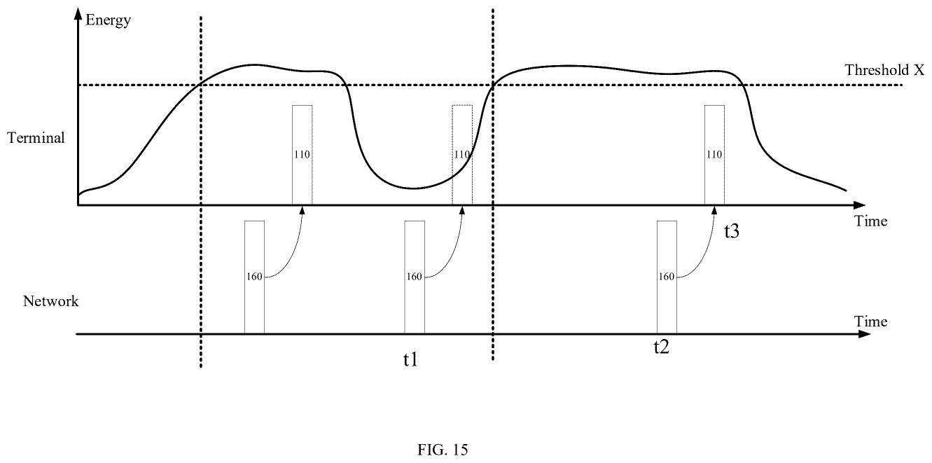

Exemplarily, as illustrated in FIG. 15, in a case where the terminal device receives scheduling information 160 from the network device at time t1, and the energy of the terminal device does not reach threshold X, the terminal device does not transmit the first information 110 and the second information (not shown) to the network device. In a case where the terminal device receives scheduling information 160 from the network device at time t2, and the energy of the terminal device reaches threshold X, the terminal device transmits the first information 110 to the network device at time t3.

By adopting the above method, the network device only needs to perform blind detection on the time-frequency domain resource indicated by the scheduling information, avoiding continuous blind detection by the network device.

Exemplarily, solution 1 is combined with solution 3. In response to the energy of the terminal device being greater than or equal to the first threshold, the terminal device transmits at least one of the first information or the second information to the network device, wherein the first information includes complete report data of the terminal device; and in response to the energy of the terminal device being less than the first threshold, the terminal device transmits the first information to the network device, wherein the first information includes partial report data of the terminal device.

By adopting the above method, the network device may acquire partial report data first in a case where the energy of the terminal device is insufficient.

Exemplarily, solution 1 is combined with solution 4. In response to the energy of the terminal device being greater than or equal to the first threshold, the terminal device transmits at least one the first information or the second information to the network device, wherein the first information includes complete report data of the terminal device; and in response to the energy of the terminal device being less than the first threshold, the terminal device transmits the second information to the network device, wherein the second information is used to identify or indicate or associate information related to the first information.

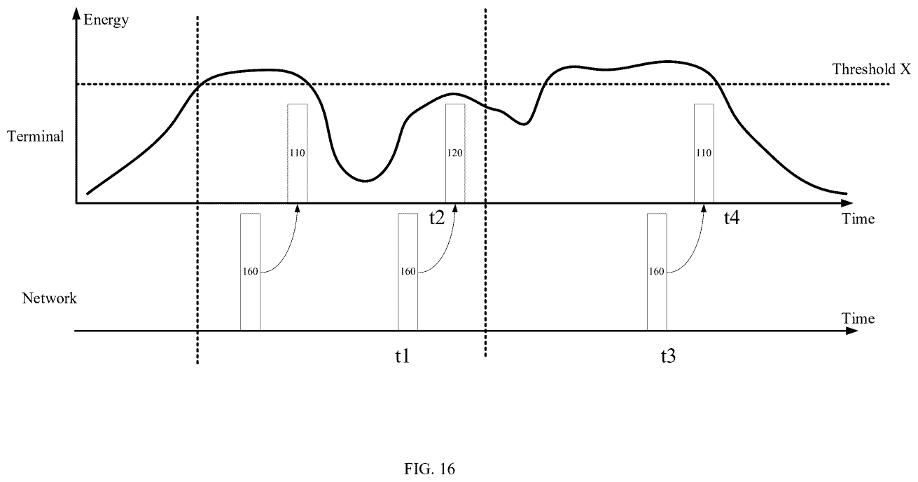

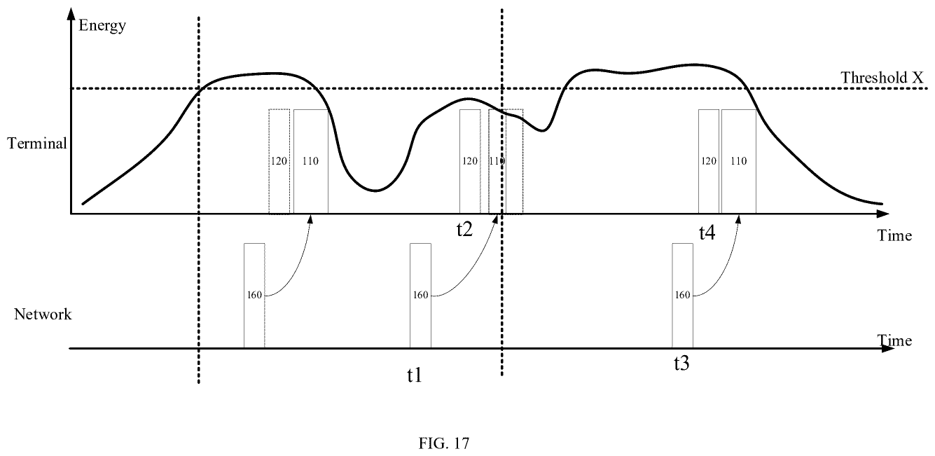

Exemplarily, as illustrated in FIG. 16, in a case where the terminal device receives scheduling information 160 from the network device at time t1, and the energy of the terminal device does not reach threshold X, the terminal device transmits the second information 120 to the network device at time t2, wherein the second information 120 is used to identify or indicate or associate information related to the first information 110; and in a case where the terminal device receives scheduling information 160 from the network device at time t3, and the energy of the terminal device reaches threshold X at this time, the terminal device transmits the first information 110 to the network device at time t4.

By adopting the above method, the network device may determine the state of the terminal device in a case where the energy of the terminal device is insufficient, avoiding empty detection.

Exemplarily, solution 1 is combined with solution 5. In response to the energy of the terminal device being greater than or equal to the first threshold, the terminal device transmits at least one of the first information or the second information to the network device, wherein the first information includes complete report data of the terminal device; and in response to the energy of the terminal device being less than the first threshold, the terminal device transmits at least one of the first information or the second information to the network device, wherein the first information includes partial report data of the terminal device.

Exemplarily, as illustrated in FIG. 17, in a case where the terminal device receives scheduling information 160 from the network device at time t1, and the energy of the terminal device does not reach threshold X, the terminal device transmits the second information 120 to the network device at time t2, wherein the second information 120 is used to indicate the energy state of the terminal device, and the terminal device transmits the first information 110 to the network device following transmission of the second information 120, wherein the first information 110 includes partial report data of the terminal device. In a case where the terminal device receives scheduling information 160 from the network device at time t3, and where the energy of the terminal device reaches threshold X, the terminal device transmits the second information 120 to the network device at time t4, and transmits the first information 110 to the network device following transmission of the second information 120, wherein the first information 110 includes complete report data of the terminal device.

By adopting the above method, the network device may determine the time-frequency domain position of the first information based on the second information, thereby avoiding incorrect detection and empty detection.

In some embodiments, in a case where the network device does not receive the complete report data of the terminal device, the method further includes the following step 660 (not shown).

In step 660, the terminal device receives the scheduling information upon elapse of a third time interval, wherein the third time interval is a time interval between two consecutive transmissions of the scheduling information by the network device.

In some embodiments, in a case where the network device has consecutively transmitted the scheduling information N times but still fails to acquire the complete report data of the terminal device, (N−1) second offset values are added to the third time interval to acquire a new time interval (i.e., a fifth time interval), wherein N is an integer greater than 1. The network device transmits the scheduling information upon elapse of the fifth time interval following the Nth transmission of the scheduling information.

Failing to acquire the complete report data of the terminal device includes the following cases:
1. The terminal device does not transmit the first information to the network device following each of the N transmissions of the scheduling information.
2. The first information, transmitted by the terminal device following an Nth transmission in the N transmissions of the scheduling information, still only includes partial report data of the terminal device.
3. The combination of a plurality of pieces of first information, transmitted by the terminal device following the N transmissions of scheduling information, still fails to cover the complete report data of the terminal device.

In some embodiments, the second offset value may be customized by the network device, or preconfigured or predefined, which is not limited in the present disclosure.

In some embodiments, the scheduling information includes at least two transmission configurations of the first information, and the transmission configuration of the at least two transmission configurations of the first information includes at least one of: a code rate of the first information, a transmission rate of the first information, report data included in the first information, a time-domain resource of the first information, transmission timing of the first information, a transmission duration of the first information, or a TBS of the first information.

In some embodiments, the terminal device may select, based on the energy state of the terminal device, one configuration from the at least two transmission configurations of the first information included in the scheduling information as the configuration for transmitting the first information. For this case, the present disclosure provides the following embodiments for exemplary illustration.

I. During the process of scheduling the terminal device for communication, the network device may support communication at at least two rates. For example, the network device may support a high-rate communication mode R1 and a low-rate communication mode R2. In the high-rate communication mode R1, the signal transmission duration is short, consuming less energy. In the low-rate communication mode R2, the signal transmission duration is longer, consuming more energy. A duration of each symbol in the high-rate R1 communication mode is less than a duration of each symbol in the low-rate R2 communication mode.

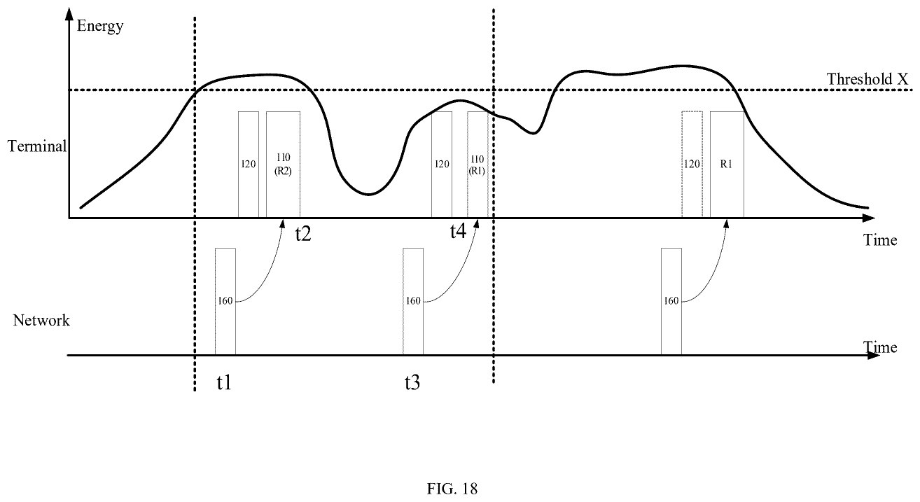

Exemplarily, as illustrated in FIG. 18, the terminal device determines the communication mode based on the energy state of the terminal device. In response to the energy of the terminal device exceeding threshold X at time t1, the terminal device selects the low-rate communication mode R2 and transmits the first information 110 and the second information 120 to the network device at time t2. In response to the energy of the terminal device being lower than threshold X at time t3, the terminal device selects the high-rate communication mode R1 and transmits the first information 110 and the second information 120 to the network device at time t4. As illustrated in FIG. 18, a time-domain length of the first information 110 at time t4 is significantly less than a time-domain length of the first information 110 at time t2.

In the above embodiment, the second information may be used to identify the rate at which the terminal device transmits the first information.

Due to the high-rate communication mode, which has high requirements on channel transmission performance, the terminal device has difficulty maintaining this mode. Therefore, the terminal device may select an appropriate transmission rate based on the energy state of the terminal device.

II. During the process of scheduling the terminal device for communication, the network device may schedule at least two different signal transmission timings. Since the network device fails to determine the energy state of the terminal device, the network device may indicate two different signal transmission timings during scheduling. For example, two signal transmission timings are scheduled at each time point T1 and T2, wherein T1<T2 (i.e., T1 is earlier than T2).

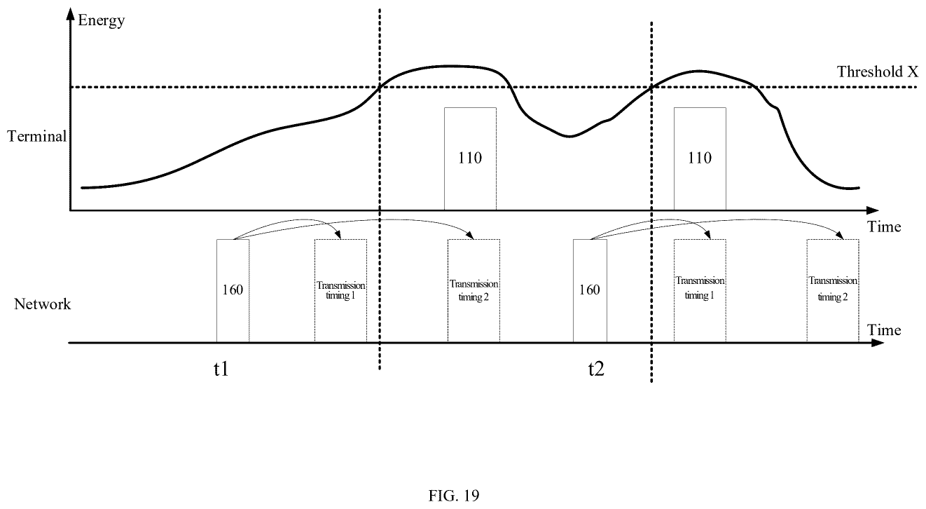

Exemplarily, as illustrated in FIG. 19, the terminal device determines the signal transmission timing based on the energy state of the terminal device. In response to the energy of the terminal device not exceeding threshold X at time t1, the terminal device selects transmission timing 2 to transmit the first information 110. In response to the energy of the terminal device exceeding threshold X at time t2, the terminal device selects transmission timing 1 to transmit the first information 110. A time interval between transmission timing 1 and the scheduling information 160 is less than a time interval between transmission timing 2 and the scheduling information 160.

In the above embodiment, the terminal device may transmit the second information to the network device, wherein the second information is used to indicate the timing at which the terminal device transmits the first information.

III. During the process of scheduling the terminal device for communication, the network device may schedule at least two different signal transmission configurations. For example, the two signal transmission configurations differ at least in terms of code rate, signal duration, time-domain resource position, duration of each symbol, code block size, etc. In addition, different signal transmission configurations require different energy consumption for transmission of the first information.

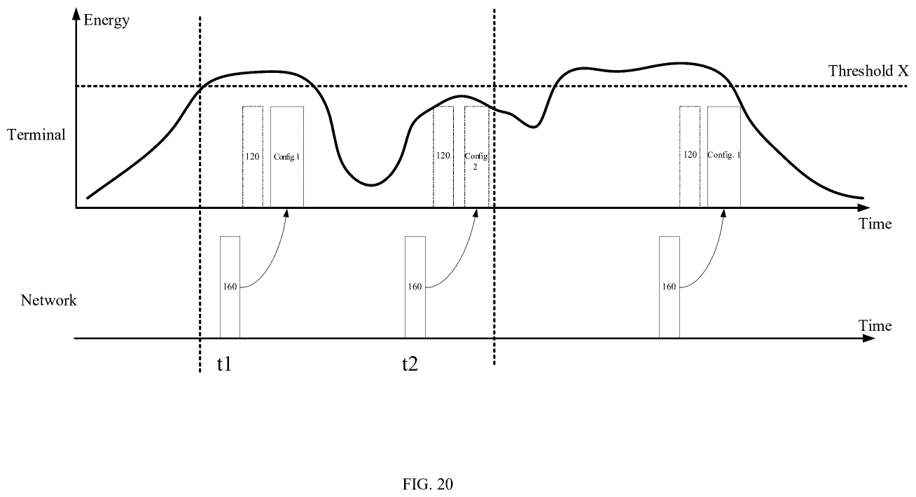

Exemplarily, as illustrated in FIG. 20, the terminal device determines a signal transmission configuration based on the energy state of the terminal device. In response to the energy of the terminal device exceeding threshold X at time t1, the terminal device transmits the first information 110 based on signal transmission configuration 1 (marked as Config. 1 in the figure). In response to the energy of the terminal device not exceeding threshold X at time t2, the terminal device transmits the first information 110 based on signal transmission configuration 2 (marked as Config. 2 in the figure).

In the above embodiment, the terminal device may transmit the second information to the network device, wherein the second information is used to indicate the signal transmission configuration adopted by the terminal device for transmission of the first information.

IV. During the process of the network device scheduling the terminal device for communication, the terminal device transmits high-priority report data based on the energy state of the terminal device.

In some embodiments, report data included in the first information is determined based on a priority of report data of the terminal device. For example, during the transmission of the first information by the terminal device, different types of report data have different priority levels. In a case where the terminal device is in an energy sufficient state, the terminal device transmits complete report data. In a case where the terminal device is in a low-energy state, the terminal device transmits the report data in descending order of priority.

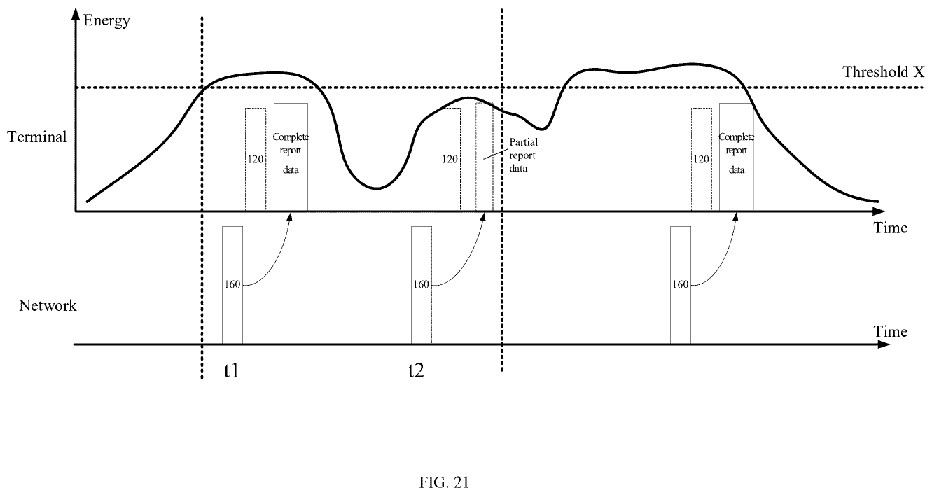

Exemplarily, as illustrated in FIG. 21, the terminal device transmits the report data based on the energy state of the terminal device. In response to the energy of the terminal device exceeding threshold X at time t1, the terminal device transmits the first information 110 including complete report data (all the report data). In response to the energy of the terminal device not exceeding threshold X at time t2, the terminal device transmits the first information 110 including only partial report data with high priority (a higher-priority portion of the report data).

In the above embodiment, the terminal device may transmit the second information to the network device, wherein the second information is used to indicate whether the first information includes all the report data.

V. During the process of the network device scheduling the terminal device for communication, the terminal device transmits the report data using a segmented transmission mode.

In some embodiments, the report data included in the first information is determined based on a segmentation configuration of report data of the terminal device. For example, during a signal transmission process of the terminal device, the terminal device determines a minimum segment for report data according to scheduling by the network device. The terminal device divides the report data to be transmitted into at least two segments based on configuration information from the network device, with each segment being self-decodable.

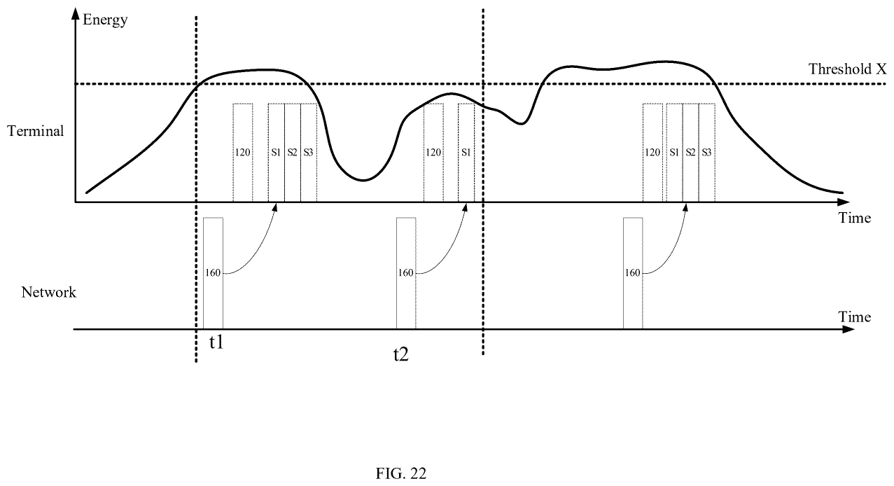

Exemplarily, as illustrated in FIG. 22, the terminal device determines a segmentation configuration of the report data based on the energy state of the terminal device. In response to the energy of the terminal device exceeding threshold X at time t1, the terminal device transmits the first information 110 including all the report data, meaning that the first information includes segment 1 (marked as S1 in the figure), segment 2 (marked as S2 in the figure), and segment 3 (marked as S3 in the figure). In response to the energy of the terminal device not exceeding threshold X at time t2, the terminal device transmits the first information 110 including only a portion of the report data (i.e., segment 1).

In some embodiments, in a case where the energy of the terminal device fails to reach the first threshold, the terminal device may determine the segment(s) to be included in the first information based on an order in which the report data is segmented. For example, the data segment(s) to be included in the first information is determined in an order of segment 1, segment 2, and segment 3. That is, in a case where the energy of the terminal device fails to reach the first threshold, segment 1 is transmitted with priority in the first information.

In some embodiments, in a case where the energy of the terminal device fails to reach the first threshold, the terminal device may determine the segment(s) to be included in the first information based on a segment index indicated by the network device. The segment index is used to represent the segment of the report data of the terminal device. In some embodiments, the network device indicates the segment index using scheduling information.

In some embodiments, in a case where the energy of the terminal device fails to reach the first threshold, the terminal device may determine the segment(s) to be included in the first information based on a priority of each segment. In some embodiments, the priority of each segment may be determined autonomously by the terminal device or based on a priority of report data corresponding to the segment.

In the above embodiment, the terminal device may transmit the second information to the network device, wherein the second information is used to indicate the segment(s) included in the first information.

According to the above embodiments, a solution where the terminal device determines the information to be transmitted to the network device based on the energy state of the terminal device, is provided in a case where data reporting is based on the scheduling by the network device. The solution may efficiently utilize the energy harvested from the environment and improve the performance of data transmission.

Device embodiments of the present disclosure are provided hereinafter, which are applicable for implementing the method embodiments of the present disclosure. For details not disclosed in the device embodiments of the present disclosure, reference may be made to the method embodiments of the present disclosure.

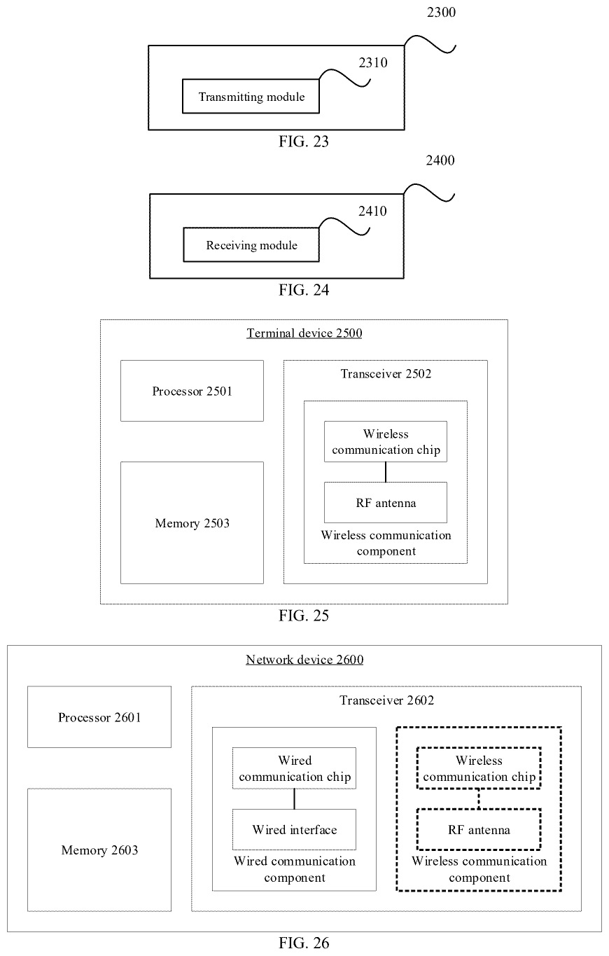

FIG. 23 is a block diagram of a wireless communication apparatus according to some embodiments of the present disclosure. The apparatus is configured to perform the wireless communication method on the terminal device side as described above. This functionality may be implemented by hardware or by hardware executing corresponding software. The apparatus may be the terminal device as described above, or may be configured within the terminal device. As illustrated in FIG. 23, an apparatus 2300 may include a transmitting module 2310.

The transmitting module 2310 is configured to transmit, based on an energy state of a terminal device, at least one of first information or second information to a network device, wherein the first information includes complete report data or partial report data of the terminal device, and the second information is used to indicate the energy state of the terminal device.

In some embodiments, the transmitting module 2310 is configured to transmit at least one of the first information or the second information to the network device in response to energy of the terminal device being greater than or equal to a first threshold.

In some embodiments, the transmitting module 2310 is configured to transmit at least one of the first information or the second information to the network device within a first time period following energy of the terminal device reaching a first threshold; or transmit at least one of the first information or the second information to the network device upon elapse of a second time period following energy of the terminal device reaching a first threshold.

In some embodiments, the transmitting module 2310 is configured to transmit the first information in a j^{th} format or the second information to the network device in response to energy of the terminal device being greater than or equal to an i^{th} threshold, i and j being positive integers, wherein the first information in each format or the second information corresponds to a threshold.

In some embodiments, the second information includes at least one of: common information; random access information; identification information of the terminal device; or sequence information.

In some embodiments, energy required to transmit the second information is less than energy required to transmit the first information.

In some embodiments, the second information is a first reference signal, and the first reference signal is used to identify or indicate transmission of the first information.

In some embodiments, the transmitting module 2310 is further configured to refrain from transmitting the first information within a first time interval following transmission of the second information; and/or transmit the first information within a second time interval following transmission of the second information; wherein the first time interval is a minimum time interval between transmission of the first information and transmission of the second information, and the second time interval is a maximum time interval between transmission of the first information and transmission of the second information.

In some embodiments, the second information is used to determine or directly or indirectly indicate a transmission configuration of the first information, and the second information is used to indicate at least one of a code rate, a coding scheme, or a time-domain length.

In some embodiments, the apparatus 2300 further includes a receiving module 2320 (not shown).

The receiving module 2320 is configured to receive a second reference signal, wherein the second reference signal is used to instruct the terminal device to transmit the first information.

In some embodiments, the second reference signal is periodic.

In some embodiments, the second reference signal is transmitted by at least one of the network device or a third-party device, the third-party device being a device other than the network device and the terminal device.

In some embodiments, synchronization is established between the third-party device and the network device.

In some embodiments, the second reference signal is used to indicate a time-domain resource for the terminal device to transmit the first information.

In some embodiments, the transmitting module 2310 is further configured to transmit, based on the energy state of the terminal device, third information to the network device, wherein the third information is used to request transmission of the first information.

The receiving module 2320 is further configured to receive a third reference signal from the network device, wherein the third reference signal is used to instruct the terminal device to transmit the first information.

In some embodiments, the third information includes at least one of identification information of the terminal device or a common sequence.

In some embodiments, the third information is used to indicate at least one of energy harvesting efficiency of the terminal device or capabilities supported by the terminal device.

In some embodiments, the receiving module 2320 is further configured to receive scheduling information from the network device, wherein the scheduling information is used to instruct the terminal device to transmit the first information.

In some embodiments, the transmitting module 2310 is configured to perform at least one of:
in response to energy of the terminal device being greater than or equal to a first threshold, transmitting at least one of the first information or the second information to the network device, wherein the first information includes the complete report data of the terminal device;
in response to energy of the terminal device being less than a first threshold, refraining from transmitting the first information and the second information to the network device;
in response to energy of the terminal device being less than a first threshold, transmitting the first information to the network device, wherein the first information includes the partial report data of the terminal device;
in response to energy of the terminal device being less than a first threshold, transmitting the second information to the network device, wherein the second information is used to identify or indicate or associate information related to the first information; or
in response to energy of the terminal device being less than a first threshold, transmitting at least one of the first information or the second information to the network device, wherein the first information includes the partial report data of the terminal device.

In some embodiments, in a case where the network device fails to receive the complete report data from the terminal device, the receiving module is further configured to receive the scheduling information upon elapse of a third time interval, wherein the third time interval is a time interval between two consecutive transmissions of the scheduling information by the network device.

In some embodiments, the scheduling information includes at least two transmission configurations of the first information, and a transmission configuration of at least two transmission configurations of the first information includes at least one of: a code rate of the first information, a transmission rate of the first information, report data included in the first information, a time-domain resource of the first information, a transmission timing of the first information, a transmission duration of the first information, or a signal TBS of the first information.

In some embodiments, report data included in the first information is determined based on a priority of report data of the terminal device.

In some embodiments, report data included in the first information is determined based on a segmentation configuration of report data of the terminal device.

In the technical solutions according to the embodiments of the present disclosure, at least one of the first information or the second information is transmitted to the network device based on the energy state of the terminal device. Transmission of the first information to the network device based on the energy state of the terminal device ensures that the data contained in the first information is parseable by the network device, thereby avoiding transmission failures, and thus preventing any impact on the communication quality between the terminal device and the network device. Transmission of the second information to the network device based on the energy state of the terminal device allows the network device to determine, based on the second information, whether the terminal device transmits the first information, and then determine whether to receive the first information, and thus the network device does not need to perform continuous blind detection, such that the power consumption of the network device is reduced.

FIG. 24 is a block diagram of a wireless communication apparatus according to some embodiments of the present disclosure. The apparatus is configured to perform the wireless communication method on the network device side as described above. This functionality may be implemented by hardware or by hardware executing corresponding software. The apparatus may be the network device as described above, or may be configured within the network device. As illustrated in FIG. 24, an apparatus 2400 may include a receiving module 2410.

The receiving module 2410 is configured to receive at least one of first information or second information from a terminal device, wherein the first information includes complete report data or partial report data of the terminal device, and the second information is used to indicate an energy state of the terminal device.

In some embodiments, the second information includes at least one of: common information; random access information; identification information of the terminal device; or sequence information.

In some embodiments, energy required to transmit the second information is less than energy required to transmit the first information.

In some embodiments, the second information is a first reference signal, and the first reference signal is used to identify or indicate transmission of the first information.

In some embodiments, the second information determines or directly or indirectly indicates a transmission configuration of the first information, and the second information is used to indicate at least one of a code rate, a coding scheme, or a time-domain length.

In some embodiments, the apparatus 2400 further includes a transmitting module 2420 (not shown).

The transmitting module 2420 is configured to transmit a second reference signal to the terminal device, wherein the second reference signal is used to instruct the terminal device to transmit the first information.

In some embodiments, the second reference signal is periodic.

In some embodiments, the second reference signal is used to indicate a time-domain resource for the terminal device to transmit the first information.

In some embodiments, the receiving module 2410 is configured to receive third information from the terminal device, wherein the third information is used to request transmission of the first information.

The transmitting module 2420 is configured to transmit a third reference signal to the terminal device, wherein the third reference signal is used to instruct the terminal device to transmit the first information.

In some embodiments, the third information includes at least one of identification information of the terminal device or a common sequence.

In some embodiments, the third information is used to indicate at least one of energy harvesting efficiency of the terminal device or capabilities supported by the terminal device.

In some embodiments, the transmitting module 2420 is further configured to transmit scheduling information to the terminal device, wherein the scheduling information is used to instruct the terminal device to transmit the first information.

In some embodiments, in a case where a network device fails to receive the complete report data from the terminal device, the transmitting module 2420 is further configured to transmit the scheduling information to the terminal device upon elapse of a third time interval, wherein the third time interval is a time interval between two consecutive transmissions of the scheduling information by the network device.

In some embodiments, the scheduling information includes at least two transmission configurations of the first information, and a transmission configuration of at least two transmission configurations of the first information includes at least one of: a code rate of the first information, a transmission rate of the first information, report data included in the first information, a time-domain resource of the first information, a transmission timing of the first information, a transmission duration of the first information, or a signal TBS of the first information.

In some embodiments, report data included in the first information is determined based on a priority of report data of the terminal device.

In some embodiments, report data included in the first information is determined based on a segmentation configuration of report data of the terminal device.

In the technical solutions according to the embodiments of the present disclosure, at least one of the first information or the second information is transmitted to the network device based on the energy state of the terminal device. Transmission of the first information to the network device based on the energy state of the terminal device ensures that the data contained in the first information is parseable by the network device, thereby avoiding transmission failures, and thus preventing any impact on the communication quality between the terminal device and the network device. Transmission of the second information to the network device based on the energy state of the terminal device allows the network device to determine, based on the second information, whether the terminal device transmits the first information, and then determine whether to receive the first information, and thus the network terminal does not need to perform continuous blind detection, such that the power consumption of the network device is reduced.

It should be noted that, in implementing functions, the apparatus provided in the above embodiments is only described by way of example based on the division of the above functional modules. In practical applications, the above functions may be allocated to and accomplished by different functional modules as needed. That is, the internal structure of the apparatus may be divided into different functional modules to perform all or part of the functions described above.

The specific ways in which each module in the apparatus of the above embodiments performs operations are described in detail in the embodiments related to the method, and are not elaborated herein. For details not elaborated in the apparatus embodiments, reference may be made to the above method embodiments.

FIG. 25 is a schematic structural diagram of a terminal device according to some embodiments of the present disclosure. A terminal device 2500 may include: a processor 2501, a transceiver 2502, and a memory 2503. The transceiver 2502 is configured to implement the transmitting or receiving function, such as implementing the functions of the transmitting module 2310 and the receiving module 2320 as described above. The processor 2501 may be configured to implement other processing functions or to control transmission and/or reception.

The processor 2501 includes one or more processing cores. The processor 2501 executes various functional applications and performs information processing by running software programs and modules.

The transceiver 2502 may include a receiver and a transmitter. For example, the receiver and the transmitter may be implemented as the same wireless communication component, which may include a wireless communication chip and an RF antenna.

The memory 2503 may be communicably connected to the processor 2501 and the transceiver 2502.

The memory 2503 may be configured to store one or more computer programs run by the processor. The one or more computer programs, when run by the processor 2501, cause the processor 2501 to perform the steps in the above method embodiments.

In some embodiments, the transceiver 2502 is configured to transmit at least one of first information or second information to a network device based on an energy state of a terminal device, wherein the first information includes complete report data or partial report data of the terminal device, and the second information is used to indicate the energy state of the terminal device.

For details not elaborated upon in the embodiments, reference may be made to the preceding embodiments, which are not repeated herein.

In addition, the memory may be implemented by any type of a volatile or non-volatile storage device or a combination thereof. The volatile or non-volatile storage device includes, but not limited to: a magnetic or optical disk, an electrically-erasable programmable read-only memory (EEPROM), an erasable programmable read-only memory (EPROM), a static random-access memory (SRAM), a read-only memory (ROM), a magnetic memory, a flash memory, and a programmable ROM (PROM).

FIG. 26 is a schematic structural diagram of a network device 2600 according to some embodiments of the present disclosure. The network device 2600 may be configured to perform the method steps performed by the network device in the above embodiments. The network device 2600 may include: a processor 2601, a transceiver 2602, and a memory 2603. The transceiver 2602 is configured to implement the transmitting or receiving function, such as implementing the functions of the receiving module 2410 and the transmitting module 2420 as described above. The processor 2601 may be configured to implement other processing functions or to control transmission and/or reception.

The processor 2601 includes one or more processing cores. The processor 2601 executes various functional applications and performs information processing by running software programs and modules.

The transceiver 2602 may include a receiver and a transmitter. For example, the transceiver 2602 may include a wired communication component, which may include a wired communication chip and a wired interface (such as an optical fiber interface). In some embodiments, the transceiver 2602 may further include a wireless communication component, which may include a wireless communication chip and an RF antenna.

The memory 2603 may be communicably connected to the processor 2601 and the transceiver 2602.

The memory 2603 may be configured to store one or more computer programs run by the processor. The one or more computer programs, when run by the processor 2601, cause the processor 2601 to perform the steps that are performed by the network device in the above method embodiments.

In addition, the memory 2603 may be implemented by any type of a volatile or non-volatile storage device or a combination thereof. The volatile or non-volatile storage device includes, but not limited to: a magnetic or optical disk, an EEPROM, an EPROM, an SRAM, an ROM, a magnetic memory, a flash memory, and a PROM.

In some embodiments, the transceiver 2602 is configured to receive at least one of first information or second information from a terminal device, wherein the first information includes complete report data or partial report data of the terminal device, and the second information is used to indicate an energy state of the terminal device.

For details not elaborated upon in the embodiments, reference may be made to the preceding embodiments, which are not repeated herein.

Some embodiments of the present disclosure further provide a computer-readable storage medium. The storage medium stores one or more computer programs. The one or more computer programs, when run by a processor, cause the processor to perform the wireless communication method on the terminal device side or the wireless communication method on the network device side as described above. In some embodiments, the computer-readable storage medium may include an ROM, a random-access memory (RAM), a solid state drive (SSD), or an optical disk, or the like. The RAM may include a resistance RAM (ReRAM) and a dynamic RAM (DRAM).

Some embodiments of the present disclosure further provide a chip. The chip includes programmable logic circuitry and/or one or more program instructions. The chip, when running, is configured to perform the wireless communication method on the terminal device side or the wireless communication method on the network device side as described above.

Some embodiments of the present disclosure further provide a computer program product. The computer program product includes one or more computer instructions stored in a computer-readable storage medium, wherein the one or more computer instructions, when read from the computer-readable storage medium and executed by a processor, cause the processor to perform the wireless communication method on the terminal device side or the wireless communication method on the network device side as described above.

It should be understood that the term “indication” mentioned in the embodiments of the present disclosure may be a direct indication, an indirect indication, or an indication that an association relationship is present. For example, “A indicates B” may mean that A directly indicates B, for example, B may be obtained through A; or may mean that A indirectly indicates B, for example, A indicates C through which B may be obtained; or may mean an association relationship is present between A and B.

In the description of the embodiments of the present disclosure, the term “corresponding” may indicate a direct corresponding relationship or an indirect corresponding relationship between two items, or an association relationship between the two items, or a relationship such as indicating and being indicated, configuring and being configured, or the like.

In the embodiments of the present disclosure, a “predefined” or “preconfigured” operation may be performed by pre-storing corresponding codes or tables in a device (e.g., a device including a terminal device and a network device), or may be performed by other means that may be used to indicate relevant information. The present disclosure does not impose any restrictions on specific methods for performing the predefined or preconfigured operation. For example, the predefined operation may be agreed in a protocol.

In the embodiments of the present disclosure, the “protocol” may refer to a standard protocol in the communication field. For example, the protocol may include an LTE protocol, an NR protocol, and related protocols applied in future communication systems, which is not limited in the present disclosure.

The term “a plurality of” herein means two or more. The term “and/or” describes an association relationship of associated objects, and it indicates three types of relationships. For example, the phrase “A and/or B” means (A), (B), or (A and B). The character “/” usually indicates an “or” relationship between the associated objects.

The phrase “greater than or equal to” herein may refer to either “greater than or equal to” or strictly “greater than”; similarly, “less than or equal to” may refer to either “less than or equal to” or strictly “less than.”

In addition, the serial numbers of the steps described herein only exemplifies one possible execution sequence among the steps. In some other embodiments, the above steps may also be executed without following the numbering sequence. For example, two steps with different serial numbers are executed simultaneously or in an order reverse to the order shown in the figures. This is not limited in the embodiments of the present disclosure.

A person skilled in the art should be aware that in the foregoing one or more examples, the functions described in the embodiments of the present disclosure may be implemented by hardware, software, firmware, or any combination thereof. The functions, when implemented by software, may be stored in a computer-readable medium or transmitted as at least one instruction or code on the computer-readable medium. The computer-readable medium includes a computer storage medium and a communication medium. The communication medium includes any medium that facilitates transfer of a computer program from one place to another. The storage medium may be any available medium accessible by a general-purpose computer or a special-purpose computer.

Described above are merely exemplary embodiments of the present disclosure and are not intended to limit the present disclosure. Any modification, equivalent replacement, and improvement, and the like, made within the spirit and principle of the present disclosure shall be fall within the protection scope of the present disclosure.

1. A wireless communication method, performed by a terminal device, the method comprising:
transmitting, based on an energy state of the terminal device, at least one of first information or second information to a network device, wherein the first information comprises complete report data or partial report data of the terminal device, and the second information is used to indicate the energy state of the terminal device.

2. The method according to claim 1, wherein transmitting at least one of the first information or the second information to the network device based on the energy state of the terminal device comprises at least one of:
transmitting at least one of the first information or the second information to the network device in response to energy of the terminal device being greater than or equal to a first threshold;
transmitting at least one of the first information or the second information to the network device within a first time period following energy of the terminal device reaching a first threshold;
transmitting at least one of the first information or the second information to the network device upon elapse of a second time period following energy of the terminal device reaching a first threshold; or
transmitting the first information in a j^{th} format or the second information to the network device in response to energy of the terminal device being greater than or equal to an i^{th} threshold, i and j being positive integers, wherein the first information in each format or the second information corresponds to a threshold.

3. The method according to claim 1, wherein the second information comprises at least one of:
common information;
random access information;
identification information of the terminal device; or
sequence information.

4. The method according to claim 1, wherein the second information is a first reference signal, the first reference signal being used to identify or indicate transmission of the first information.

5. The method according to claim 1, further comprising:
refraining from transmitting the first information within a first time interval following transmission of the second information; and/or
transmitting the first information within a second time interval following transmission of the second information;
wherein the first time interval is a minimum time interval between transmission of the first information and transmission of the second information, and the second time interval is a maximum time interval between transmission of the first information and transmission of the second information.

6. The method according to claim 1, wherein:
the second information is used to determine or directly or indirectly indicate a transmission configuration of the first information; and
the second information is used to indicate at least one of a code rate, a coding scheme, or a time-domain length.

7. The method according to claim 1, further comprising:
receiving a second reference signal, wherein the second reference signal is used to instruct the terminal device to transmit the first information, and the second reference signal is used to indicate a time-domain resource for the terminal device to transmit the first information;
wherein the second reference signal is transmitted by at least one of the network device or a third-party device, the third-party device being a device other than the network device and the terminal device.

8. The method according to claim 1, further comprising:
transmitting, based on the energy state of the terminal device, third information to the network device, wherein the third information is used to request transmission of the first information; and
receiving a third reference signal from the network device, wherein the third reference signal is used to instruct the terminal device to transmit the first information;
wherein the third information comprises at least one of identification information of the terminal device or a common sequence, and the third information is used to indicate at least one of energy harvesting efficiency of the terminal device or capabilities supported by the terminal device.

9. The method according to claim 1, wherein prior to transmitting at least one of the first information or the second information to the network device, the method further comprises:
receiving scheduling information from the network device, wherein the scheduling information is used to instruct the terminal device to transmit the first information.

10. The method according to claim 9, wherein transmitting at least one of the first information or the second information to the network device based on the energy state of the terminal device comprises at least one of:
in response to energy of the terminal device being greater than or equal to a first threshold, transmitting at least one of the first information or the second information to the network device, wherein the first information comprises the complete report data of the terminal device;
in response to energy of the terminal device being less than a first threshold, refraining from transmitting the first information and the second information to the network device;
in response to energy of the terminal device being less than a first threshold, transmitting the first information to the network device, wherein the first information comprises the partial report data of the terminal device;
in response to energy of the terminal device being less than a first threshold, transmitting the second information to the network device, wherein the second information is used to identify or indicate or associate information related to the first information; or
in response to energy of the terminal device being less than a first threshold, transmitting at least one of the first information or the second information to the network device, wherein the first information comprises the partial report data of the terminal device.

11. The method according to claim 10, wherein:
the scheduling information comprises at least two transmission configurations of the first information, wherein each of the at least two transmission configurations of the first information comprises at least one of:
a code rate of the first information;
a transmission rate of the first information;
report data included in the first information;
a time-domain resource of the first information;
a transmission timing of the first information;
a transmission duration of the first information; or
a signal transport block size (TBS) of the first information.

12. A communication device, comprising: a processor and a memory storing one or more computer programs, wherein the one or more programs, when loaded and run by the processor, cause the processor to:
receive at least one of first information or second information from a terminal device, wherein the first information comprises complete report data or partial report data of the terminal device, and the second information is used to indicate an energy state of the terminal device.

13. The communication device according to claim 12, wherein the second information comprises at least one of:
common information;
random access information;
identification information of the terminal device; or
sequence information.

14. The communication device according to claim 12, wherein the second information is a first reference signal, the first reference signal being used to identify or indicate transmission of the first information.

15. The communication device according to claim 12, wherein:
the second information determines or directly or indirectly indicates a transmission configuration of the first information; and
the second information is used to indicate at least one of a code rate, a coding scheme, or a time-domain length.

16. The communication device according to claim 12, wherein the one or more programs, when loaded and run by the processor, further cause the processor to:
transmit a second reference signal to the terminal device, wherein the second reference signal is used to instruct the terminal device to transmit the first information, and the second reference signal is used to indicate a time-domain resource for the terminal device to transmit the first information.

17. The communication device according to claim 12, wherein the one or more programs, when loaded and run by the processor, further cause the processor to:
receive third information from the terminal device, wherein the third information is used to request transmission of the first information; and
transmit a third reference signal to the terminal device, wherein the third reference signal is used to instruct the terminal device to transmit the first information;
wherein the third information comprises at least one of identification information of the terminal device or a common sequence, and the third information is used to indicate at least one of energy harvesting efficiency of the terminal device or capabilities supported by the terminal device.

18. The communication device according to claim 12, wherein the one or more programs, when loaded and run by the processor, further cause the processor to:
transmit scheduling information to the terminal device, wherein the scheduling information is used to instruct the terminal device to transmit the first information.

19. The communication device according to claim 18, wherein:
the scheduling information comprises at least two transmission configurations of the first information, wherein each of the at least two transmission configurations of the first information comprises at least one of:
a code rate of the first information;
a transmission rate of the first information;
report data included in the first information;
a time-domain resource of the first information;
a transmission timing of the first information;
a transmission duration of the first information; or
a signal transport block size (TBS) of the first information.

20. A communication device, comprising:
a processor and a memory storing one or more computer programs, wherein the one or more programs, when executed by the processor, cause the processor to:
transmit, based on an energy state of a terminal device, at least one of first information or second information to a network device, wherein the first information comprises complete report data or partial report data of the terminal device, and the second information is used to indicate the energy state of the terminal device.
